(19) United States
(12) Patent Application Publication
(10) Pub. No.: US 2023/0387426 A1
(43) Pub. Date: Nov. 30, 2023

(54) FUEL CELL DEVICE AND METHOD AND ALSO SYSTEM FOR PRODUCING A FUEL CELL DEVICE

(71) Applicant: EKPO Fuel Cell Technologies GmbH, Dettingen (DE)

(72) Inventors: Arno Bayer, Filderstadt (DE); Andreas Schmid, Moessingen (DE)

(73) Assignee: EKPO Fuel Cell Technologies GmbH, Dettingen (DE)

(21) Appl. No.: 18/323,181

(22) Filed: May 24, 2023

(30) Foreign Application Priority Data
May 31, 2022 (DE) 10 2022 113 745.7

(51) Int. Cl. H01M 8/0228; H01M 8/0267; H01M 8/0247

(52) U.S. Cl. CPC H01M 8/0228; H01M 8/0267; H01M 8/0247

(57) ABSTRACT

Proposed is a bipolar plate for a fuel cell device, wherein the bipolar plate is formed from a plurality of flat products, in particular arranged one above the other in a vertical direction, wherein one or each of at least some of the plurality of flat products has an alignment structure or a plurality of alignment structures, and at least one alignment structure of at least one flat product, at least in the state in which the plurality of flat products are arranged one above the other, is accessible and/or is exposed by the other one or more of the plurality of flat products.

### CROSS-REFERENCE TO RELATED PATENT APPLICATION

This patent application relates to the subject matter disclosed in and claims the benefit of German application No. 10 2022 113 745.7, filed May 31, 2022, the teachings and disclosure of which are hereby incorporated in their entirety by reference thereto for all purposes.

### BACKGROUND OF THE INVENTION

The invention relates to a fuel cell device and also a method and a system for producing a fuel cell device.

In addition, the invention relates to a flat component, in particular a bipolar plate, in particular for a fuel cell unit, and to a use of a flat component, in particular a bipolar plate, and to a method and a system for producing a flat component of this kind.

### SUMMARY OF THE INVENTION

The problem addressed by the invention lies in improving a flat component in particular for a fuel cell device, a fuel cell device, and a method and a system for producing a flat component and/or a fuel cell device.

In embodiments of the invention, the underlying problem is solved by a flat component which is formed from a plurality, that is two or more, of flat products, in particular arranged one above the other in a vertical direction, wherein exactly one or each of at least some of the plurality of flat products has exactly one alignment structure or a plurality, that is two or more, of alignment structures, and at least one alignment structure of at least one flat product, at least in the state in which the plurality of flat products are arranged one above the other, is exposed by the other one or more of the plurality of flat products.

The flat component is expediently configured for a fuel cell device and in particular is a bipolar plate.

In particular, an advantage of the solution according to the invention is that the at least one alignment structure in the at least one flat product is reachable conveniently, without disturbing the other flat product or the other flat products, and therefore the at least one flat product with at least one alignment structure can be aligned relative to the other one or more of the plurality of flat products with the aid of the at least one alignment structure, and the plurality of flat products can thus be arranged one above the other more easily and/or more precisely, in particular for joining together.

The at least one flat product with at least one alignment structure can advantageously be held at this alignment structure also during the joining together of the plurality of flat products, so that, during the joining process, the alignment of the plurality of flat products relative to one another is maintained, even if, for example, protruding structures of one flat product come into contact with another flat product, which thus results in the risk that the flat products will shift relative to one another and/or will spring apart from one another.

In embodiments of the invention, the problem stated at the outset is solved by a fuel cell device which comprises at least one fuel cell unit having at least one flat component, for example a bipolar plate, wherein the at least one flat component is formed from a plurality, that is two or more, of flat products in particular arranged one above the other in a vertical direction, wherein exactly one or each of at least some of the plurality of flat products has exactly one alignment structure or a plurality, that is two or more, of alignment structures and the at least one alignment structure of at least one flat product, at least in the state in which the plurality of flat products are arranged one above the other, is exposed by the other one or more of the plurality of flat products.

An advantage can be seen in particular in the fact that the at least one flat product with the exposed alignment structure can be aligned independently of the other one or more of the plurality of flat products, and therefore the flat products in the at least one flat component can be arranged more precisely relative to one another, and the flat component can be formed with increased precision, whereby the fuel cell unit of the fuel cell device advantageously has increased performance, since for example electrical contacts are formed in an improved manner and/or fluid-guiding structures for an oxidation medium and/or a fuel medium and/or a product medium and/or a temperature-control medium are formed more precisely.

For example, the alignment of the at least one flat product with the at least one alignment structure relative to the other flat product or the other flat products is made possible more easily by the alignment structure, and assembly of the flat component, in particular forming a bipolar plate, and/or of the fuel cell device is hereby made possible more cost-effectively and/or at least partly automated manufacture is made possible.

At least some of the plurality of flat products preferably have one alignment structure or a plurality of alignment structures, wherein the one alignment structure or the plurality of alignment structures for one flat product or for different flat products are formed the same, at least in principle. For example, at least some alignment structures have at least one feature that is the same and/or at least some alignment structures have at least one different feature. These possible configurations with the same and/or different features are what is to be understood when, for the sake of easier readability, reference is made to just “one alignment structure” and/or “at least one alignment structure for at least one flat product” or the like, unless a different understanding is explained explicitly in the context.

Furthermore, the reference to “the at least one other flat product” shall be understood hereinafter such that, depending on the number of the plurality of flat products, the one other flat product and/or the other flat products from the plurality of flat products is/are meant.

It is advantageously provided that at least one alignment structure of at least one flat product is formed so as to be free of interaction with the at least one other flat product.

This is expedient in particular since the at least one flat product with its at least one alignment structure therefore does not interact with the at least one other flat product and thus can be aligned by means of the at least one alignment structure independently of the at least one other flat product.

It is particularly advantageous if at least one alignment structure of at least one flat product is formed as a continuous aperture in the flat product, wherein in particular the aperture is formed continuously in the vertical direction.

An alignment structure of simple construction is hereby advantageously provided.

In particular, the flat product can be expediently aligned and held in the aligned position by the alignment structure formed as an aperture, for example by an alignment element that reaches through the aperture.

In particular, the at least one flat component, in particular each of the plurality of flat components, extends in each case two-dimensionally substantially in a geometric plane of extent spanned by two directions of areal extent, wherein the vertical direction runs at least approximately perpendicularly to the geometric plane of extent. In particular, an extent of the flat component in its vertical direction is much smaller, for example at least ten times smaller, in particular at least fifty times smaller, than an extent of the flat component in its geometric plane of extent.

Advantageously, at least one alignment structure in at least one flat product is formed in a locally delimited manner.

In particular, at least one alignment structure in at least one flat product has a maximum dimension of extent and a minimum dimension of extent at least approximately parallel to the geometric plane of extent of the flat component.

The maximum dimension of extent of at least one alignment structure is preferably at most 15 mm, in particular at most 10 mm, for example at least 5 mm in size. For example, the maximum dimension of extent of at least one alignment structure is at least 1 mm, preferably at least 2 mm, in particular at least 3 mm in size.

The minimum dimension of extent of at least one alignment structure is preferably at most 10 mm, in particular at most 5 mm in size. In particular, the minimum dimension of extent of at least one alignment structure is at least 1 mm in size, preferably at least 2 mm in size, for example at least 3 mm in size.

In some expedient embodiments, the alignment structure is elongate and in particular the maximum dimension of extent corresponds here to an extent of the alignment structure in a direction of elongate extent, and for example the minimum dimension of extent corresponds to a width of the alignment structure transverse, in particular at least approximately perpendicular, to the direction of elongate extent.

In particularly advantageous embodiments, at least one elongate alignment structure is a slot.

For example, in the case of an elongate alignment structure, it is expedient that the at least one flat product can be aligned with this alignment structure not only in position, but also in orientation.

In some expedient embodiments, at least one alignment structure in at least one flat product is an at least substantially circular alignment structure, in which in particular the minimum dimension of extent and the maximum dimension of extent are at least approximately the same size.

For example, at least one at least substantially circular alignment structure is a round hole.

For example, in the case of an at least substantially circular alignment structure, it is expedient that on the basis of this alignment structure the flat product can be aligned at least in its position, however, since the at least substantially circular alignment structure is substantially rotationally symmetrical, rotation of the flat product about the alignment structure is still possible at least within certain limits, so that, in the case of a plurality of alignment structures in the flat product, for example an excessive over-determination in the arrangement of the flat product can be avoided.

In other expedient embodiments, the alignment structure has more complex forms.

In particular, the flat component has an edge region, which, in particular based on the extent of the flat component in its geometric plane of areal extent, is situated at the edge of the extent.

For example, the flat component has, in its edge region, an opening or a plurality of openings for further component parts of the fuel cell device, for example a distributor structure for fluids, in particular for an oxidation medium and/or a fuel medium and/or a product medium.

In particular, the flat component has a function region.

The function region of the flat component is expediently surrounded peripherally by the edge region.

Advantageously, at least one alignment structure in at least one flat product is formed in the edge region of the flat component.

No further details have yet been provided with regard to the accessibility and/or the exposure of the at least one alignment structure in at least one flat product.

In particular, at least one alignment structure in at least one flat product is accessible and/or exposed at least in an exposure direction. For example, at least in the exposure direction, the at least one alignment structure is preferably reachable in particular to align and/or hold the flat product and in particular is reachable without disturbing the at least one other flat product.

It is preferably provided that the exposure direction, at least in the case of one alignment structure in at least one flat product, runs at least approximately parallel to the vertical direction.

It is particularly advantageous if at least one alignment structure in at least one flat product together with a tolerance region surrounding this alignment structure is accessible and/or is exposed by the at least one other flat product.

In particular, an advantage of this is that, additionally to the at least one alignment structure, the tolerance region surrounding this alignment structure is thus also reachable, and therefore the alignment structure is at all times accessible and/or exposed within predefined tolerance limits, for example during the alignment of the flat products.

In particular, the tolerance region surrounds the corresponding, at least one alignment structure transversely, in particular at least approximately perpendicularly, to the exposure direction.

The tolerance region preferably surrounds a corresponding alignment structure fully in a peripheral direction.

In particular, it is provided that the tolerance region, in a direction running away from the alignment structure that is surrounded by this tolerance region, wherein this direction that runs away runs in particular at least approximately perpendicularly to the exposure direction, has at least one extent which is greater than or equal to a tolerance in the alignment of this flat product, in particular relative to the at least one other flat product.

It is particularly advantageous if, in a projection of at least one alignment structure of at least one flat product, in particular in a projection of at least one alignment structure together with its tolerance region surrounding it, at least one other of the plurality of flat products, in particular all of the other of the plurality of flat products, are material-free.

It is particularly advantageous if, relative to at least one alignment structure of at least one flat product, at least one other flat product, in particular all of the other flat products, in each case has a cutout, wherein the cutout is arranged congruently with the least one alignment structure.

The cutout is advantageously arranged congruently with the at least one alignment structure together with its tolerance region surrounding it.

In some preferred embodiments, the cutout in the at least one other flat product having this cutout is formed within the extent of the flat product, in particular within its extent parallel to the geometric plane of extent, so that in particular such a cutout is surrounded peripherally by material of the corresponding flat product.

In some advantageous embodiments, the cutout is formed at the edge of the at least one other flat product having this cutout, in such a way that the edge of the flat product at the cutout is set back, in particular is set back relative to an edge of the flat product having the alignment structure and/or relative to an edge of the flat component.

In particular, a projection of the at least one alignment structure and in particular a projection of this alignment structure together with the tolerance region surrounding this alignment structure onto a geometric plane which is at least substantially parallel to the geometric plane of extent and in which the flat product having the cutout at least substantially extends is outside the extent of the flat product having the cutout.

The alignment structure is advantageously formed in a precise manner, in particular with a tolerance that is smaller than or at most the same size as a tolerance that is allowed for the alignment of the flat product to be aligned.

The at least one cutout in at least one other flat product is sufficiently large for the alignment structure to be accessible and/or exposed, and it is sufficient to form the cutout roughly, that is to say with low precision, since the cutout merely has to ensure that the alignment structure, preferably together with its tolerance region, is accessible and/or exposed.

It is particularly advantageous if the flat component, at least in the region of at least one alignment structure, has a passage in the exposure direction from at least one outer side of the flat component to at least this at least one alignment structure in the region of which the passage is formed.

The at least one alignment structure is thus exposed by means of the passage and in particular by the at least one other flat product co-forming the passage.

It is particularly expedient if the passage from the at least one outer side to an outer side that is opposite this first-mentioned outer side in the exposure direction is formed continuously through the flat component.

In particular, the passage is formed here by a cutout in the at least one other flat product and for example by an alignment structure formed as an aperture.

It is particularly advantageous here if an extent, which is measured in a direction of extent running at least substantially perpendicularly to the exposure direction, of at least one passage is minimal at the alignment structure co-forming this passage.

It is preferably provided that at least one passage has its narrowest region at the alignment structure co-forming this passage.

An alignment element is thus expediently able, through the passage, to precisely engage the flat product to be aligned, at the alignment structure in the region of the minimal extent and/or the narrowest region, without at the same time disturbing an alignment of the at least one other flat product.

It is particularly expedient if at least one flat product has at least two, that is to say exactly two or more than two, alignment structures.

In particular, it is thus made possible, with the at least two alignment structures, to align the flat product provided with them in the geometric plane of extent not only in respect of its position but also in respect of its orientation.

In some advantageous embodiments, the at least two alignment structures at least substantially the same.

In other advantageous embodiments, the at least two alignment structures are different.

It is preferably provided that in the case of at least one flat product at least two alignment structures are arranged distanced far from one another.

For example, a distance between two alignment structures arranged distanced far from one another is substantially the same as or greater than an extent of the flat product parallel to the geometric plane of extent of the flat component, in particular at least substantially the same as and/or greater than a minimum and/or maximum extent parallel to the geometric plane of extent.

In particular, the function region is arranged between two alignment structures arranged distanced far from one another.

It is preferably provided that two alignment structures arranged distanced far from one another are arranged at different edge portions of the flat product provided with the alignment structures.

No further details have yet been provided in respect of a relative arrangement of alignment structures in different flat products from the plurality of flat products.

In particular, it is provided that respective alignment structures in different flat products are arranged offset from one another, in particular are arranged offset from one another in a direction running at least substantially perpendicularly to the respective exposure direction and/or in each case are arranged offset from one another in a direction running at least substantially parallel to the geometric plane of extent.

The respective exposure directions of the alignment structures in different flat products advantageously run at least approximately parallel to one another.

In some advantageous embodiments, it is provided that in each case at least one alignment structure is formed in at least some of the plurality of flat products and that these alignment structures are arranged close to one another.

For example, it is provided that the flat component has at least one locally delimited alignment portion and in each case an alignment structure is formed in the least one alignment portion at least in some of the plurality of flat products.

In particular, the flat component has at least two locally delimited alignment portions, which in particular are arranged distanced far from one another.

Here, it is thus provided advantageously that in each case there is formed precisely one alignment structure in at least two alignment portions, in particular arranged distanced far from one another, in the same flat product, and in at least some of the plurality of flat products there is formed in each case one alignment structure in each of the at least two alignment portions, with said alignment structures being arranged in particular close to one another.

In particular, the fuel cell device comprises a line system, which has at least one line device for a fuel medium and a line device for an oxidation medium and for example a line device for a temperature-control medium.

In particular, the line device for the fuel medium is configured to supply a fuel medium to at least one cell unit, preferably to supply into at least one reaction chamber, and to distribute the fuel medium in the at least one cell unit and to discharge chemically unconverted fuel medium fractions and/or at least parts of a product medium away from at least the one cell unit, in particular away from at least one reaction chamber.

In particular, the line device for the oxidation medium is configured to supply an oxidation medium to at least one cell unit, preferably to supply into at least one reaction chamber, and to distribute the oxidation medium in the at least one cell unit and to discharge chemically unconverted oxidation medium fractions and/or at least parts of a product medium away from the at least one cell unit, in particular away from at least one reaction chamber.

In particular, in the one reaction chamber or the preferably plurality of reaction chambers, the supplied fuel medium and the supplied oxidation medium react and are converted chemically at least in part into a product medium, with electrical energy being provided during this process.

Each cell unit expediently comprises one reaction chamber or preferably a plurality of reaction chambers.

In particular, the temperature-control medium in the line device is used for a temperature-control medium for controlling the temperature of the at least one fuel cell unit.

In particular, the line device for a temperature-control medium is part of a temperature-control device for the at least one fuel cell unit.

The temperature-control device is expediently configured and/or the temperature-control medium is expediently provided to control the temperature of at least one flat component, expediently a bipolar plate, advantageously a stack of flat components and/or to control the temperature of at least one reaction chamber and the components forming the at least one reaction chamber.

In expedient embodiments, it is provided that at least one flat component, in particular at least one flat component forming a bipolar plate or a membrane component, is at least part of at least the line device for a fuel medium and/or at least part of the line device for an oxidation medium and/or at least part of the line device for a temperature-control medium.

Here, the flat component is preferably part of the line device for distributing the corresponding medium in at least one cell unit of the at least one fuel cell unit.

The at least one flat component advantageously has, here, fluid-guiding structures for the medium and advantageously at least co-forms at least one reaction chamber.

In particular, the fuel cell unit comprises at least one electrical device for providing electrical energy, wherein at least part of the electrical energy is provided in particular in at least one reaction chamber as part of the electrical device, and advantageously a plurality of cell units having at least one reaction chamber are connected in particular in series in the electrical device.

At least one flat component, in particular at least one flat component forming a bipolar plate, is advantageously at least part of the electrical device.

The at least one flat component preferably forms here electrical contacts of the electrical device and/or at least one electrode of a cell unit having at least one reaction chamber.

Here, the advantages of the invention are particularly beneficial, since the precise alignment of the flat products results in an improved guidance of the corresponding medium in the line device and a better seal of the corresponding line device, and/or the precise alignment of the flat products allows improved electrical contacting.

It is particularly expedient if the fuel cell unit has at least one stack which comprises at least a plurality of flat components, wherein at least some of the plurality of flat components have one or more of the previously explained, for example, optional features and/or at least some of the plurality of flat components are formed as bipolar plates.

A flat component, for example a bipolar plate, and/or a fuel cell device, which flat component/fuel cell device comprises one or more of the above-explained, for example optional features, is preferably produced by a method which has at least one, for example optional feature from the features explained hereinafter in conjunction with a method.

Alternatively or additionally, the problem stated at the outset is also solved by the use of a flat component, which is formed from a plurality of flat products arranged in particular one above the other in a vertical direction, for a fuel cell device, in particular for a stack of at least one fuel cell unit of the fuel cell device, wherein one or each of at least some of the plurality of flat products has an alignment structure or a plurality of alignment structures and advantageously the at least one flat component has one or more of the above-explained, for example optional features and/or is produced by a method which has one or more of the below, for example optional features, which are explained in conjunction with a method.

In particular, for the use, the flat component is formed as a bipolar plate.

Alternatively or additionally, the problem stated at the outset is solved by a method for producing a flat component, in particular a bipolar plate, wherein the flat component is formed from a plurality of flat products, wherein the method comprises at least the steps of providing the plurality of flat products and of forming at least one alignment structure at least in one flat product.

Here, it is advantageous in particular that the at least one flat product is formed with at least one alignment structure, so that at least this one flat product can be aligned, advantageously precisely, relative to at least one other flat product, and the flat component can thus be produced precisely and/or automated production of the flat component, in particular automated provision of the flat products and automated alignment of the at least one flat product, is made possible.

Alternatively or additionally, the problem stated at the outset is solved by a method for producing a fuel cell device which comprises at least one fuel cell unit having at least one flat component, wherein the at least one flat component is formed from a plurality of flat products, wherein the method comprises at least the steps of providing the plurality of flat products and of forming at least one alignment structure at least in one flat product.

In particular, an advantage of this is that the at least one flat component can be produced by forming at least one flat product with at least one alignment structure more precisely and/or at least in a partly automated manner, and therefore the performance of the at least one fuel cell unit is improved and/or the production costs therefore can be reduced, wherein the fuel cell unit typically comprises a plurality of such flat components, and so the benefits are multiplied correspondingly.

In particular, the method comprises at least one step in order to form the flat product and/or the fuel cell device having one or more of the above-explained, for example optional features which have been explained in conjunction with the flat component and/or the fuel cell device.

In particular, the method for producing at least one flat component, in particular a bipolar plate, is configured for use of the flat component in an above-explained use.

In particular, in the method, at least one alignment structure is formed with at least one of the, for example optional, features explained above in conjunction with the alignment structure.

In particularly advantageous embodiments, it is provided that in at least one flat product at least one alignment structure is formed at least in part by a separation method.

In particular, a precise forming of the alignment structure is hereby made possible expediently.

In particular, an at least partial severing makes it possible to form an alignment structure free of interaction with the at least one other flat product.

It is particularly advantageous if at least one alignment structure is formed fully by at least one separation method, wherein for example said alignment structure is formed in a plurality of steps and/or by application of different separation methods.

It is particularly expedient if the at least one separation method comprises a shearing, at least in part. In particular, a very precise forming of the alignment structure is hereby made possible.

For example, a material region to be removed in the at least one flat product in order to form the alignment structure is separated at least in part, preferably at least for the most part, by shearing and is fully separated in a subsequent step.

In particularly advantageous embodiments, it is provided that a function region and at least one alignment structure are formed at least in part in at least one flat product by means of the same tool.

Here, an advantage of the at least partial forming of the function region and of the at least partial forming of at least one alignment structure in the same tool is in particular that the relative position of the alignment structure in relation to the function region is configured so as to be precisely reproducible.

In particular, the tool is a punching tool.

Alternatively or additionally, the problem stated at the outset is also solved by a method for producing a flat component, in particular a bipolar plate, wherein the flat component is formed from a plurality of flat products, wherein the method comprises at least the steps of providing the plurality of flat products, aligning at least one flat product of the plurality of flat products independently of the other one or more of the plurality of flat products with the aid of at least one alignment structure in this at least one flat product, and joining together the, in particular aligned, flat products.

In particular, an advantage of this is that the least one flat product is aligned independently of the at least one other flat product, and therefore it can be aligned more precisely and a disturbance of the at least one other flat products, for example of its correct and preferably more precise alignment, is at least reduced or even avoided entirely.

In particular, the alignment of the at least one flat product is not influenced by the at least one other flat product.

At least some of the plurality of flat products are preferably aligned independently of one another.

Alternatively or additionally, the problem stated at the outset is also solved by a method for producing a fuel cell device which comprises at least one fuel cell unit having at least one flat component, wherein the flat component is formed from a plurality of flat products, and wherein the method comprises at least the steps of providing the plurality of flat products, aligning at least one flat product of the plurality of flat products independently of the other one or more of the plurality of flat products with the aid of at least one alignment structure in this at least one flat product, and joining together the, in particular aligned, flat products.

In particular, such a production of the fuel cell device is simplified since at least one flat product is aligned independently of the at least one other flat product, and preferably the produced fuel cell device is improved since the flat component is produced more precisely and therefore subsequent production steps can be performed better and for example with smaller tolerances and/or the more precisely produced flat component cooperates better with the further components of the fuel cell device.

It is advantageously provided that the alignment of the at least one flat product with at least one alignment structure is performed by at least one alignment element engaging the at least one alignment structure.

In particular, the at least one alignment element is an alignment element of a system for producing the flat component and/or of the system for producing the fuel cell device.

It is advantageously provided here that a respective alignment element engages merely one flat product.

Preferably, an alignment element engaging a flat product engages it merely at the alignment structure.

In particular, it is provided that at least one alignment element for aligning one or more flat products does not interact with the other one or more of the plurality of flat products.

Here, it is advantageously achieved that the alignment of the one flat product is not disturbed by the at least one other flat product and/or the other flat product, in particular the alignment thereof, is not disturbed by the alignment of the one flat product.

In particular, at least one alignment element aligning a flat product and this flat product itself cooperate mechanically, in particular at the alignment structure.

The alignment element and the alignment structure preferably cooperate by way of positive locking.

The alignment element expediently has a form complementary to the alignment structure.

For example, the alignment element has a thickness which corresponds to an extent of the alignment structure, in particular on extent of the alignment structure at least approximately perpendicular to the exposure direction.

It is preferred if the alignment element extends in an elongate fashion.

In particular, the thickness of the alignment element is measured at least approximately perpendicularly to a longitudinal extent of the alignment element.

A thickness of the alignment element along its longitudinal extent is preferably constant at least in part, in particular at least for the most part, for example apart from a region at an element end of the alignment element.

In particularly advantageous embodiments, it is provided that at least one alignment element is a rigid alignment element.

In particular, a simple and reliable production is hereby achieved, since the rigid alignment element is advantageously unsusceptible to errors and/or is low-maintenance and/or a precise alignment over multiple production cycles is made possible.

An automation of the provision of the at least one flat product and its alignment is also expediently facilitated with the rigid alignment element, since this flat product merely has to be brought into engagement with the rigid alignment element.

It is particularly expedient if at least one alignment element at least engages in a passage in the flat products arranged one above the other, said passage corresponding to at least one alignment structure, in order to align the flat component formed with this alignment structure.

It is particularly advantageous if at least one alignment element engages in a passage in the flat products arranged one above the other, said passage corresponding to at least one alignment structure, in order to align the flat component formed with this alignment structure.

The arrangement of the flat products one above the other and also the interaction of the at least one alignment element with merely one flat product are hereby realized in a simple way.

The passage is advantageously formed with at least one of the features explained above in conjunction with a passage.

It is particularly expedient if the formed passage has its smallest extent and/or its narrowest region in the region of the alignment structure of the flat product to be aligned.

In particular, a particularly efficient provision and alignment of one or at least some of the plurality of flat products is hereby made possible, since the flat products can be arranged one above the other and in so doing the alignment element, in order to align the flat product, at least engages in the passage and interacts merely with the flat product to be aligned.

It is particularly advantageous if at least one alignment element and one alignment structure of the flat product to be aligned by this alignment element cooperate following the alignment of this flat product at least during a further production step.

The at least one alignment element and the at least one alignment structure of the flat product aligned by this alignment element expediently cooperate at least until the aligned flat product has been joined together with at least one other flat product, preferably until all of the plurality of flat products have been joined together.

It is thus advantageously achieved that the aligned flat product, by cooperation with the alignment element, remains in its aligned position and/or orientation, in particular also, when being joined together with at least one other flat product, when these flat products come into contact with one another and therefore, for example, these flat products would otherwise shift relative to one another as a result of protruding structures in the function region.

At least some alignment elements, in particular all alignment elements, preferably cooperate by their respective alignment structures during at least one further production step, in particular until at least some, preferably all, of the plurality of flat products have been joined together.

In particular, as a result of the cooperation of the alignment element with the alignment structure, the flat product having this alignment structure is held in the aligned arrangement by the alignment element.

In advantageous embodiments it is provided that at least one alignment element, preferably at least some, in particular at least most, for example all, of the, for example rigid, alignment elements is/are adjusted prior to the assembly of the flat component.

In particular, the one alignment element or at least some alignment elements is/are adjusted in a system and fixed in the adjusted state, and then a quick and precise production of such flat components can be achieved, for example in an automated manner or manually, since the flat products to be aligned merely have to be brought into engagement with the at least one alignment element intended to align the corresponding flat product and are aligned already by the engagement, since the adjustment has already been performed.

In particularly advantageous embodiments, it is provided that correct alignment of at least two of the plurality of flat products relative to one another is checked, in particular on the basis of respective control patterns formed in these flat products.

In particular, the control patterns are structures formed in the flat product in question.

In particular, at least one control pattern is formed so as to be free of interaction with the at least one other flat product.

In particular, at least one control pattern is formed at least in part by at least one separation method.

For example, at least one control pattern is formed at least in part by a shearing and in particular by a severing of a region that is to be removed in order to form the control pattern.

For example, correct alignment of at least two flat products is checked by verifying that corresponding control patterns in the at least two flat products lie one above the other with accurate positioning, in particular within specified tolerance limits.

At least two, in particular all, of the plurality of flat products can be joined together in a wide range of different ways.

In particular, a positive-locking and/or substance-to-substance bonded and/or force-locking connection between at least two flat products is intended here, and such a connection is produced.

In particularly preferred embodiments, it is provided that at least two of the plurality of flat products are joined to one another by welding. Preferably, all of the plurality of flat products are joined to at least one further flat product by welding.

The method preferably comprises the step of finishing the flat component.

In particular, the method comprises the step of finishing at least the fuel cell unit, in particular the fuel cell device.

The method is preferably carried out using a system which has one or at least some of the system features explained hereinafter.

Alternatively or additionally, the problem stated at the outset is solved by a system for producing a flat component, in particular a bipolar plate, wherein the flat component, that is to say for example the bipolar plate, is formed from a plurality of flat products.

Alternatively or additionally, the problem stated at the outset is solved by a system for producing a fuel cell device which comprises at least one fuel cell unit having at least one flat component, for example at least one bipolar plate, wherein the flat component, for example at least one bipolar plate, is formed from a plurality of flat products.

It is provided here in embodiments of the invention that the system has at least one alignment element for aligning at least one flat product independently of the other one or more flat products.

At least one flat product can thus be aligned by the at least one alignment element independently of the at least one other flat product, whereby the flat component advantageously can be formed more precisely and/or an at least partial automation of the production is at least simplified.

In particular, it is provided that the system comprises at least two alignment elements, that is to say exactly two alignment elements or more than two alignment elements, in order to align at least one flat product.

In expedient embodiments it is provided that the system has in each case at least one alignment element, in particular in each case at least two alignment elements, for at least some, preferably at least most, in particular for each, of the plurality of flat products.

The one alignment element or the plurality of alignment elements can be formed differently. The plurality of alignment elements are preferably formed the same, at least in principle. In particular, it is expedient if the plurality of alignment elements have one feature that is the same or several features that are the same, wherein in some advantageous embodiments at least two alignment elements have at least one different feature.

These different combinations of configurations of the alignment elements are also included when, hereinafter, reference is made for the sake of easy readability merely to “at least one alignment element”. The wording “at least one alignment element” in conjunction with a feature is to be understood insofar as the one alignment element or one of the plurality of alignment elements has this feature, or at least some, preferably at least most, for example all, of the plurality of alignment elements have this feature.

In particularly advantageous embodiments, it is provided that at least one alignment element is a rigid alignment element.

Here, the rigid alignment element is in particular low-maintenance, and precise and quick alignment is preferably made possible with the rigid alignment element. A rigid alignment element is expedient for automated loading and arrangement of the plurality of flat products and also for manual arrangement of the flat products.

It is particularly advantageous if at least one alignment element is formed tapering towards an element end of this alignment element.

In particular, an arrangement of the flat products, for example an engagement of the alignment element in an aperture in particular forming an alignment structure and/or in a passage corresponding to an alignment structure and/or in a cutout in a flat product, is hereby simplified.

At least one alignment element is preferably an alignment element extending in an elongate fashion, so that the plurality of flat products can be arranged expediently one above the other along the longitudinal extent of the alignment element.

In particularly preferred embodiments, it is provided that the system has at least one tool for simultaneously at least partially forming a function region and at least partially forming at least one alignment structure in at least one flat product.

The function region and the alignment structure are thus advantageously formed at least in part by the same tool and are thus formed precisely and reproducibly relative to one another.

In particular, the system is configured to form a flat component, in particular a bipolar plate, having one or at least some of the above-explained, for example optional features, and in particular has a device necessary for this purpose and/or a tool necessary for this purpose.

In expedient embodiments, the system is configured to form a fuel cell device having one or at least some of the above-explained, for example optional features, and in particular has a device necessary for this purpose and/or a tool necessary for this purpose.

The system is preferably configured to form a flat component, in particular a bipolar plate, and/or a fuel cell device by a method having one or at least some of the above-explained features and/or method steps, and in particular has a device necessary for this purpose and/or a tool necessary for this purpose.

Above and hereinafter, features which are described as being provided in particular and/or expediently and/or by way of example and/or preferably and/or advantageously and/or the like are optional features, which, for example, form inventive further developments, but are not absolutely necessary for the underlying inventive concept.

The description of solutions according to the invention comprises in particular the various combinations of features defined by the following consecutively numbered embodiments:
1. A bipolar plate (143) for a fuel cell device (100), wherein the bipolar plate (143) is formed from a plurality of flat products (262), in particular arranged one above the other in a vertical direction (158), wherein one or each of at least some of the plurality of flat products (262) has an alignment structure (312) or a plurality of alignment structures (312), and at least one alignment structure (312) of at least one flat product (262), at least in the state in which the plurality of flat products (262) are arranged one above the other, is exposed by the other one or more of the plurality of flat products (262).
2. A fuel cell device (100) comprising at least one fuel cell unit (110) having at least one flat component (125, 143, 144), wherein the at least one flat component (125, 143, 144) is formed from a plurality of flat products (262), in particular arranged one above the other in a vertical direction (158), wherein one or each of at least some of the plurality of flat products (262) has an alignment structure (312) or a plurality of alignment structures (312), and at least one alignment structure (312) of at least one flat product (262), at least in the state in which the flat products are arranged one above the other, is exposed by the other one or more of the plurality of flat products (262).
3. A bipolar plate (143) in accordance with embodiment 1 and/or fuel cell device (100) in accordance with embodiment 2, wherein at least one alignment structure (312) of at least one flat product (262) is formed so as to be free of interaction with the at least one other flat product (262).
4. A bipolar plate (143) and/or fuel cell device (100) in accordance with the preceding embodiments, wherein at least one alignment structure (312) of at least one flat product (262) is formed as an aperture (316) in the flat product (262), said aperture being formed in particular continuously in the vertical direction (158).
5. A bipolar plate (143) and/or fuel cell device (100) in accordance with the preceding embodiments, wherein at least one alignment structure (312) in at least one flat product (262) is formed in a locally delimited manner.
6. A bipolar plate (143) and/or fuel cell device (100) in accordance with the preceding embodiments, wherein at least one alignment structure (312) in at least one flat product (262) is accessible and/or is exposed at least in an exposure direction (322), wherein in particular the exposure direction (322) runs at least approximately parallel to the vertical direction (158).
7. A bipolar plate (143) and/or fuel cell device (100) in accordance with the preceding embodiments, wherein at least one alignment structure (312) in at least one flat product (262) together with a tolerance region (326) surrounding this alignment structure (312) is accessible and/or exposed.
8. A bipolar plate (143) and/or fuel cell device (100) in accordance with the preceding embodiment, wherein the tolerance region (326), in a direction which runs away from the alignment structure (312) which is surrounded by this tolerance region (326), has at least one extent (328) which is greater than or the same as a tolerance for the alignment of this flat product (262).
9. A bipolar plate (143) and/or fuel cell device (100) in accordance with the preceding embodiments, wherein in a projection of at least one alignment structure (312) of at least one flat product (262) in the exposure direction (322) thereof, the other one or more of the plurality of flat products (262) are material-free.
10. A bipolar plate (143) and/or fuel cell device (100) in accordance with the preceding embodiments, wherein, relative to at least one alignment structure (312) of at least one flat product (262), at least one other flat product (262) has a cutout (332), wherein the cutout (332) is arranged congruently with the at least one alignment structure (312).
11. A bipolar plate (143) and/or fuel cell device (100) in accordance with the preceding embodiments, wherein the flat component (125, 143, 144), formed in particular as a bipolar plate, at least in the region of at least one alignment structure (312) has a passage (334) in the exposure direction (322) from at least one outer side (165, 167) of the flat component to at least this at least one alignment structure (312), and in particular the passage (334) from the at least one outer side (312) to an outer side (165, 167) opposite this outer side (165, 167) in the exposure direction (322) is formed continuously through the flat component (125, 143, 144).
12. A bipolar plate (143) and/or fuel cell device (100) in accordance with the preceding embodiments, wherein an extent, which is measured in a direction of extent running at least substantially perpendicularly to the exposure direction (322), of at least one passage (334) is minimal at the alignment structure (312) co-forming this passage.
13. A bipolar plate (143) and/or fuel cell device (100) in accordance with the preceding embodiments, wherein at least one flat product (262) has at least two alignment structures (312).
14. A bipolar plate (143) and/or fuel cell device (100) in accordance with the preceding embodiments, wherein respective alignment structures (312) in different flat products (262) are arranged relative to one another offset from one another.
15. A bipolar plate (143) and/or fuel cell device (100) in accordance with the preceding embodiments, wherein in each case at least one alignment structure (312) is formed in at least some of the plurality of flat products (262), and these alignment structures (312) are arranged close to one another.
16. A fuel cell device (100) in accordance with the preceding embodiments, wherein at least one flat component (125, 143, 144) of the at least one fuel cell unit (110) is at least part of at least one line device (114, 116, 134) for a fuel medium and/or an oxidation medium and/or a temperature-control medium, and/or in that at least one flat component (125, 143, 144) of the at least one fuel cell unit (110) is at least part of an electrical device.
17. A fuel cell device (100) in accordance with the preceding embodiments, wherein at least one flat component (125, 143, 144) of the at least one fuel cell unit (110) is a bipolar plate, and/or in that the at least one fuel cell unit (110) has at least one stack (127) which comprises at least a plurality of flat components (125, 143, 144) having one or more of the features of the preceding embodiments.
18. A bipolar plate (143) and/or fuel cell device (100), in particular having at least one feature of one of the preceding embodiments, wherein it is produced by a method in accordance with the following method embodiments.
19. A use of at least one flat component (125, 143, 144), in particular a bipolar plate (143), for a fuel cell device (100), in particular in accordance with the preceding embodiments, wherein the at least one flat component (125, 143, 144) has at least one feature of one of the preceding embodiments and/or is produced by a method which has at least one feature of one of the following method embodiments, and/or by a system which has at least one feature of one of the following embodiments directed to a system.
20. A method for producing a flat component (125, 143, 144), in particular a bipolar plate (143), in particular a flat component (125, 143, 144) having at least one feature of one of the preceding embodiments directed to a bipolar plate (143), wherein the flat component (125, 143, 144) is formed from a plurality of flat products (262), wherein the method comprises at least the steps of providing the plurality of flat products (262) and of forming at least one alignment structure (312) at least in one flat product (262).
21. A method for producing a fuel cell device (100) which comprises at least one fuel cell unit (110) having at least one flat component (125, 143, 144), in particular for producing a fuel cell device (100) having at least one feature of one of the preceding embodiments directed to a fuel cell device (100), wherein the at least one flat component (125, 143, 144) is formed from a plurality of flat products (262), wherein the method comprises at least the steps of providing the plurality of flat products (262) and of forming at least one alignment structure (312) at least in one flat product (262).
22. A method in accordance with the preceding embodiments directed to a method, wherein in at least one flat product (262) at least one alignment structure (312) is formed at least in part by at least one separation method.
23. A method in accordance with the preceding embodiments directed to a method, wherein in at least one flat product (262) a function region (125, 143, 144) and at least one alignment structure (312) are formed at least in part using the same tool.
24. A method, in particular in accordance with the preceding embodiments directed to a method, for producing a flat component (125, 143, 144), in particular a bipolar plate (143), wherein the flat component (125, 143, 144) is formed from a plurality of flat products (262), wherein the method comprises at least the steps of providing the plurality of flat products (262), aligning at least one flat product (262) of the plurality of flat products (262) independently of the other one or more of the plurality of flat products (262) with the aid of at least one alignment structure (312) in this at least one flat product (262), and joining together the in particular aligned flat products (262).
25. A method, in particular in accordance with the preceding embodiments directed to a method, for producing a fuel cell device (100) which comprises at least one fuel cell unit (110) having at least one flat component (125, 143, 144), wherein the flat component (125, 143, 144) is formed from a plurality of flat products (262), wherein the method comprises at least the steps of providing the plurality of flat products (262), aligning at least one flat product of the plurality of flat products (262) independently of the other one or more of the plurality of flat products (262) with the aid of at least one alignment structure (312) in this at least one flat product (262), and joining together the in particular aligned flat products (262).
26. A method in accordance with the preceding embodiments directed to a method, wherein the at least one flat product (262) with at least one alignment structure (312) is aligned by at least one alignment element (314) engaging the at least one alignment structure (312).
27. A method in accordance with the preceding embodiments directed to a method, wherein at least one alignment element (314) for aligning one or more flat products (262) does not interact with the other one or more of the plurality of flat products (262).
28. A method in accordance with the preceding embodiments directed to a method, wherein at least one alignment element (314) is a rigid alignment element (314).
29. A method in accordance with the preceding embodiments directed to a method, wherein at least one alignment element (314) at least engages in a passage (334), corresponding to at least one alignment structure (312), in the flat products (262) arranged one above the other, in particular reaches through the passage (334), to align the flat component (262) formed with this alignment structure (312).
30. A method in accordance with the preceding embodiments directed to a method, wherein at least one alignment element (314) and at least one alignment structure (312) of the flat product (262) to be aligned by this alignment element (314) cooperate following the alignment of this flat product (262) at least during a further production step, in particular at least until the plurality of flat products (262) have been joined together.
31. A method in accordance with the preceding embodiments directed to a method, wherein, due to the cooperation of the alignment element (314) with the alignment structure (312), the flat product (262) having this alignment structure (312) is held in the aligned arrangement by the alignment element (314).
32. A method in accordance with the preceding embodiments directed to a method, wherein at least one alignment element (314) is adjusted prior to the assembly of the flat component (125, 143, 144).
33. A system for producing a flat component (125, 143, 144), in particular a bipolar plate (143), and/or a fuel cell device (100) which comprises at least one fuel cell unit (110) having at least one flat component (125, 143, 144), wherein the flat component (125, 143, 144) is formed from a plurality of flat products (262), wherein the system has at least one alignment element (314) for aligning at least one flat product (262) independently of the other one or more of the plurality of flat products (262).
34. A system in accordance with the preceding embodiment, wherein the system has, in each case, at least one alignment element (314), in particular at least two alignment elements (314), for each of the plurality of flat products (262).
35. A system in accordance with the preceding embodiments directed to a system, wherein at least one alignment element (314) is a rigid alignment element (314).
36. A system in accordance with the preceding embodiments directed to a system, wherein at least one alignment element (314) is formed tapering towards an element end (428).
37. A system in accordance with the preceding embodiments directed to a system, wherein the system (AG) has at least one tool for simultaneously at least partially forming a function region (125, 143, 144) and partially forming at least one alignment structure (312) in at least one flat product (262).

### BRIEF DESCRIPTION OF THE DRAWINGS

Preferred features and, for example, advantages of the invention are the subject of the following detailed description and the graphical depiction of an exemplary embodiment in different variants.

In the drawings:

FIG. 1 shows a schematic depiction of an exemplary embodiment of a fuel cell device which comprises at least one fuel cell unit having a stack of a plurality of flat components;

FIG. 2 shows a plurality of flat components to be arranged one above the other for the stack;

FIG. 3 shows a plan view of a variant of a flat component;

FIG. 4 shows an enlarged depiction of a detail of a flat component in the region of an adjustment marking;

FIG. 5 shows a stack of a plurality of flat components arranged on top of one another, wherein adjustment markings for one flat component are not covered by a flat component arranged there above and are detectable for a detection apparatus;

FIG. 6 shows a plan view of a flat component formed of a plurality of flat products, wherein alignment structures formed in a flat product are accessible;

FIG. 7 shows a sectional depiction of a flat component formed from a plurality of flat products in the region of a function region provided with structures;

FIG. 8 shows a plan view of a variant of a flat component;

FIG. 9 shows an enlarged depiction of a detail of the flat component according to FIG. 8 in the region of an alignment portion with accessible alignment structures and for example control structures and for example with adjustment markings;

FIG. 10 shows a detailed depiction of flat products with alignment structures which are accessible through a cutout in another flat product;

FIG. 11 shows a depiction similar to FIG. 10 with a variant of the cutout; and

FIG. 12 shows a detailed depiction of a system with alignment elements for aligning and holding flat products.

### DETAILED DESCRIPTION OF THE INVENTION

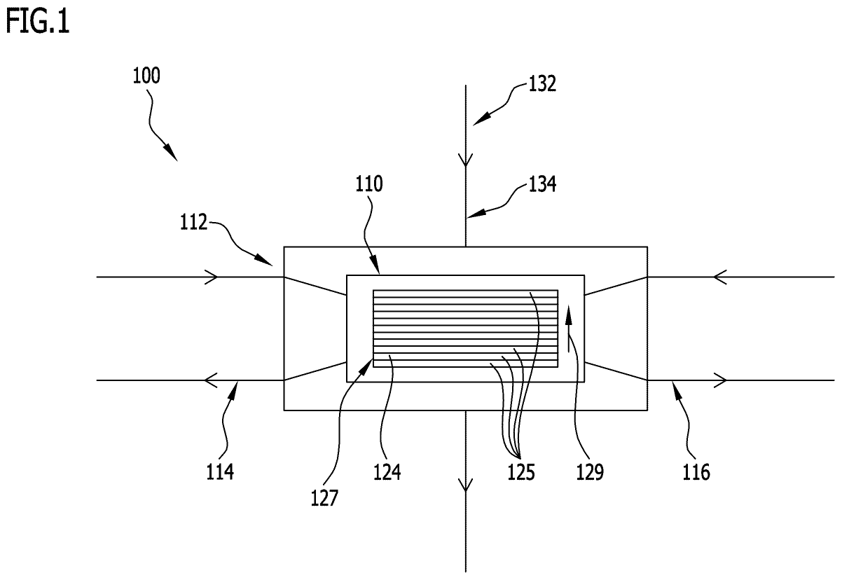

An exemplary embodiment of a fuel cell device denoted as a whole by 100 comprises at least one fuel cell unit 110 and in particular a line system, denoted in its entirety by 112, comprising at least one line device 114 for a fuel medium and a line device 116 for an oxidation medium, wherein the line devices 114, 116 are connected to the at least one fuel cell unit 110 and are formed partially therein, as is shown by way of example and schematically in FIG. 1.

The at least one fuel cell unit 110 comprises a plurality of cell units 124, wherein the fuel medium and the oxidation medium are chemically converted at least in part into a product medium in the cell units, and in particular electrical energy is provided during this process.

In particular, the cell units 124 are connected in series.

The cell units 124 are formed from flat components 125, and the flat components 125 are arranged one above the other in a stack 127 in a stacking direction 129.

By means of the line device 114 for the fuel medium, the fuel medium can be supplied, in particular as a constituent of an anode fluid mixture, to an anode side of the fuel cell unit 110 and respective anode sides of the individual cell units 124, and a residual anode fluid mixture, which in particular comprises the fuel medium fractions supplied to the at least one fuel cell unit 110 but not chemically converted therein and/or fractions of the product medium and/or constituents of the supplied anode fluid mixture, is dischargeable again from the cell units 124 and from the at least one fuel cell unit 110.

By means of the line device 116 for the oxidation medium, the oxidation medium can be supplied, in particular as a constituent of a cathode fluid mixture, to a cathode side of the at least one fuel cell unit 110 and respective cathode sides of the individual cell units 124, and a residual cathode fluid mixture, which in particular comprises the oxidation medium fractions supplied to the at least one fuel cell unit 110 but not chemically converted therein and/or constituents of the product medium and/or parts of the supplied cathode fluid mixture, is dischargeable again from the cell units 124 and from the at least one fuel cell unit 110.

For example, a temperature-control device 132 is also provided in order to keep the at least one fuel cell unit 110 in a temperature range admissible for correct operation thereof.

The temperature-control device 132 is preferably configured for on-demand cooling and/or for on-demand heating of the at least one fuel cell unit 110, in particular depending on an operating state of the fuel cell device.

In particular, the temperature-control device 132, as part of the line system 112, comprises a line device 134 for a temperature-control medium for supplying a temperature-control medium to the fuel cell unit 110 and to the individual cell units 124 and for discharging the temperature-control medium from the individual cell units 124 and the at least one fuel cell unit 110, wherein the temperature-control medium, after having been supplied and prior to being discharged, is in heat-exchanging contact with the fuel cell unit 110, in particular with the individual cell units 124, expediently with the plurality of flat components 125.

In particular, the plurality of flat components 125 comprise flat components formed as bipolar plates 143 and in particular at least some flat components formed as membrane components 144.

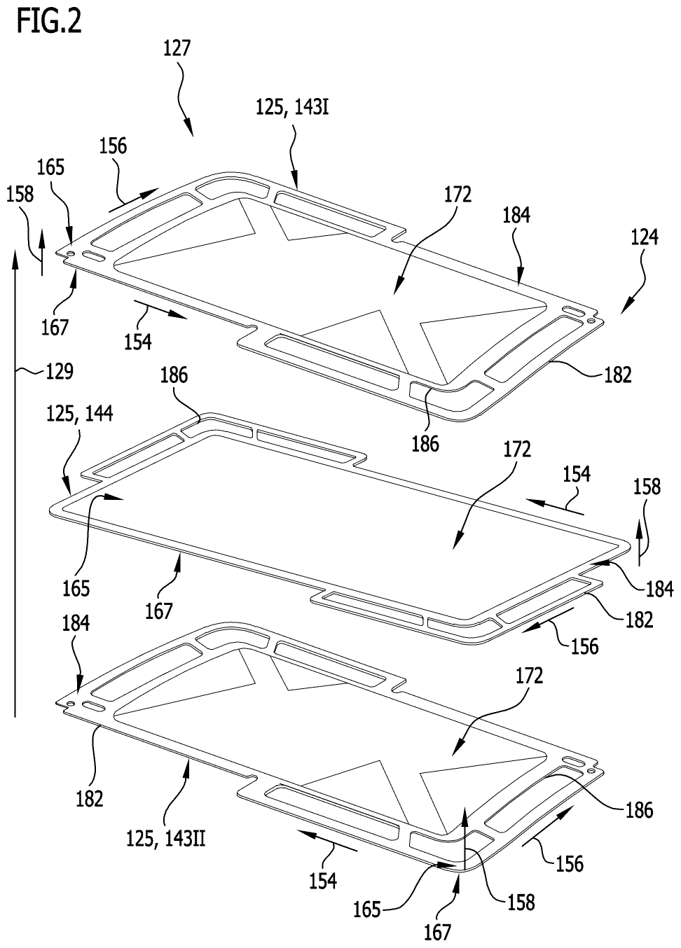

In particular, as is shown by way of example in FIG. 2 in an exploded depiction, in each case a flat component formed as a membrane component 144 is arranged between every two flat components formed as bipolar plates 143, here for example between the two bipolar plates 143I and 143II, and these flat components thus together at least co-form a respective cell unit 124.

In particular, flat components 125 arranged adjacently to one another, for example a respective bipolar plate 143 and a respective membrane component 144, are fixedly connected to one another, preferably at least fluid-tightly in some portions.

A seal is expediently formed at least between adjacent flat components 125, in particular between a respective bipolar plate 143 and a respective membrane component 144, said seal being molded on for example and/or having a sealing strip and/or being applied by screen printing.

In particular, in each case two bipolar plates 143 form here at least one reaction chamber, in which a membrane of a membrane component 144, arranged between the two bipolar plates 143, expediently extends, wherein oxidation medium and fuel medium supplied to the reaction chamber chemically react, with electrical energy being provided during the chemical reaction.

The bipolar plates 143 are expediently formed as anode and cathode for an individual cell unit 124.

In particular, the fuel medium is supplied to a part of the reaction chamber delimited by the membrane of the membrane component 144 and by one of the two bipolar plates 143, and the oxidation medium is supplied to a part of the reaction chamber delimited by the membrane of the membrane component 144 and the other of the two bipolar plates 143. The fuel medium and the oxidation medium begin to interact across the membrane, in particular charged particles pass through the membrane from one part of the reaction chamber into the other part of the reaction chamber and oppositely charged particles pass across an electric circuit from one part of the reaction chamber to the other part of the reaction chamber.

In particular, the flat components 125 in each case extend two-dimensionally in two directions of areal extent 154 and 156 running at least substantially perpendicularly to one another and each spanning a respective geometric plane of areal extent.

Typically, the respective planes of areal extent of the plurality of flat components 125 in the state stacked one above the other in the stack 127 run at least substantially parallel to one another and at least substantially perpendicularly to the stacking direction 129.

In particular, an extent of a particular flat component 125 in its vertical direction 158, running substantially perpendicularly to the directions of areal extent 154 and 156, is much smaller, in particular at least 10 times smaller, for example at least 100 times smaller, than the extent of the flat component 125 in its directions of areal extent 154, 156, wherein in particular the direction of height extent 158 in the stacked state of the flat components 125 in the stack 127 runs at least substantially parallel to the stacking direction 129.

The flat components 125 have respective outer sides 165 and 167, which are opposite in the vertical direction 158 of the flat components and which extend two-dimensionally in the directions of areal extent 154 and 156.

For example, the outer sides 165, 167 have a different height structuring in the vertical direction 158, as will be explained hereinafter in greater detail.

In particular, outer sides 165, 167 facing one another in the stack 127 of flat components 125 stacked directly on top of one another abut against one another at least in part.

In particular, in the case of some flat components, which are expediently formed as a bipolar plate 143, in each case one of the outer sides 165, 167 thereof is associated with one of every two cell units 124 arranged adjacently to one another.

For example, some flat components 125 formed in particular as membrane components 144 are arranged in a respective cell unit 124.

At least some, preferably at least most, of the plurality of flat components 125 have a respective function region 172, in which in particular there are arranged function structure parts, wherein the one function structure part or the plurality of function structure parts in the respective function region 172 serve to fulfil at least one function of the respective flat component 125.

For example, the flat components formed as membrane component 144 have, in their function region 172, at least one membrane, in particular for dividing at least one reaction chamber.

The flat components 125 formed as bipolar plates 143 expediently have, in particular, height-profiled fluid-guiding structures as function structure parts, which are formed for example at least in part as channel structures. In particular, at least some fluid-guiding structures form the reaction chamber at least in part. In particular, at least some fluid-guiding structures form, at least in part, line portions for a fluid.

In particular, at least some of the fluid-guiding structures are part of the line device 114 for the fuel medium and/or are part of the line device 116 for the oxidation medium. In particular, some of the line portions are configured to supply the anode fluid mixture or the cathode fluid mixture at least to one reaction chamber and some line portions are configured to discharge the residual anode fluid mixture or the residual cathode fluid mixture from at least one reaction chamber.

For example, at least some of the fluid-guiding structures are part of the line device 134 and guide the temperature-control medium in particular in order to provide heat-exchanging contact in the region of the function region 172.

The fluid-guiding structures advantageously pass through at least a majority of the function region 172 of a flat component 125 and for example at least some of the fluid-guiding structures 174 have branched structures.

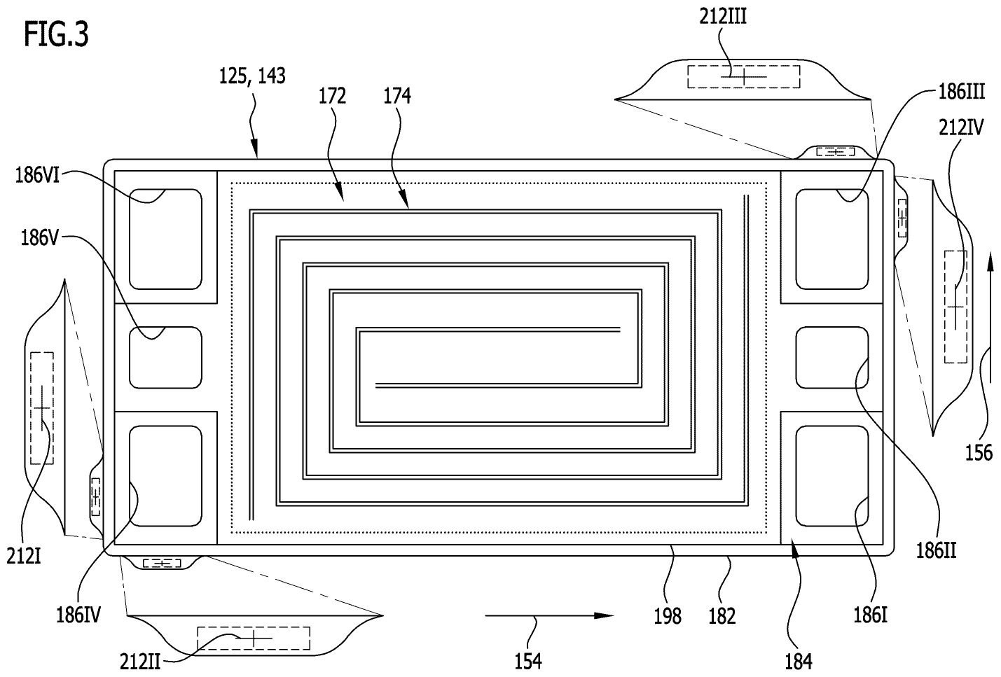

In particular, the fluid-guiding structures have a complex configuration and are shown merely schematically in simplified form in the Figs, for example in FIG. 3.

In particular, some flat components, in particular which are formed as a bipolar plate 143, have electrical function structure parts in their respective function region 172, in particular in order to form the electrode, that is to say in particular, depending on the side of the bipolar plate, in order to form the anode or cathode, and/or for electrical connection to an electrode of an adjacent cell unit 124.

The flat components 125, 143, 144 have an edge 182, up to which the respective flat component 125, 143, 144 extends in its respective plane of areal extent, and wherein the edge runs in a closed manner peripherally.

In addition, the flat components 125, 143, 144 have a respective edge region 184, which extends inwards from the edge 182, and wherein the edge region 184 advantageously surrounds the function region 172 in a closed manner peripherally.

In particular, a plurality of openings 186 for reaching through to other components are formed in the edge region 184, as shown by way of example in FIGS. 2 and 3.

For example, at least four, expediently six openings 186I to 186VI are formed, in which, as parts of the line devices 114, 116 for the fuel medium and the oxidation medium and for example the line device 134 of the temperature-control medium, there is arranged a respective distributor structure for supplying and discharging the respective medium, wherein the distributor structure is often also referred to as a manifold.

In particular, at least every two adjacent flat components 125 are fixedly connected to one another, in particular welded, at their edge regions 184.

At least one weld seam 198, in particular comprising a plurality of portions, preferably runs in the edge region 184, with at least two successive flat components 125, 143, 144 being connected to one another fixedly and for example fluid-tightly by said weld seam.

In particular, some portions of the weld seam 198 are formed in such a way that at least a partial course of the weld seam runs around the function region 172 in a closed manner peripherally.

Some portions of the weld seam 198 are preferably formed in such a way that openings 186, here for example the openings 186I, 186III, 186IV and 186VI, are in each case run around in a closed manner peripherally by a respective partial course of the weld seam 198, and at least some openings 186 are separated from the edge 182, further openings 186 and the function region 172 by respective portions of the weld seam 198.

In the case of at least some flat components 125, here in particular in the case of the flat components formed as a bipolar plate 143, line portions are expediently formed in particular with so-called gas ports, which run between a region with an opening 186, edged in a closed manner by a partial course of the weld seam 198, in which there is arranged a distributor structure for a medium, and the function region 172, in order to connect these fluid-conductingly in a defined manner and to allow a corresponding medium to be supplied or discharged.

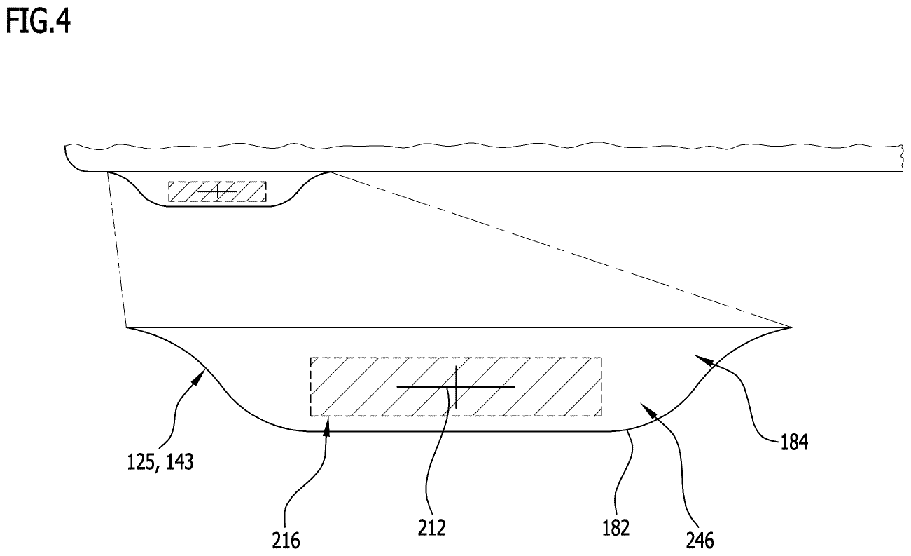

In particular, at least some of the plurality of flat components 125, advantageously at least some, in particular at least most, of the flat components 125 formed as bipolar plates 143 have an adjustment marking 212 or a plurality of adjustment markings 212, for example adjustment markings 212I, 212II, 212III, 212IV, as shown by way of example in FIGS. 3 and 4.

In particular, the plurality of adjustment markings 212 are formed the same in principle, and the reference to “the adjustment marking” is to be understood as reference to at least one adjustment marking, preferably at least some, for example at least most, of the plurality of adjustment markings 212, and a Roman numeral denoting a specific adjustment marking is appended to the reference numeral only if reference is to be made to a certain adjustment marking.

In particular, the adjustment marking 212 is intended for adjustment of the marked flat component 125 during assembly of the fuel cell device 100 when arranging the flat components 125 one above the other in the stacking direction 129 to form the stack 127.

The adjustment marking 212 is advantageously an optically high-contrast marking so as to be easily detected by an optical detection apparatus.

In particular, the adjustment marking 212 is at least substantially thickness-neutral, that is to say a thickness of the marked flat component 125 in the vertical direction 158 thereof is at least substantially uninfluenced by the adjustment marking 212.

The adjustment marking is advantageously formed on a flat portion formed continuously with material and in particular is formed on the portion merely close to the surface, for example on and/or at the surface of the portion and/or at most is formed with a shallow penetration depth starting from the surface into the material of the portion.

It is particularly expedient if the adjustment marking 212 is a pattern for example welded in by laser welding.

In particular, the welded-in pattern of the adjustment marking 212 is intended merely for marking and does not form a join between different parts.

The adjustment marking 212 is preferably formed in a predefined position region 216, as shown by way of example in FIG. 4.

The adjustment marking 212 is preferably formed in the edge region 184, wherein the position region 216 is preferably situated adjacently to the edge 182.

The adjustment marking 212, or the plurality of adjustment markings 212, can assume a wide range of different configurations, which are expedient for detection. In particular, the plurality of adjustment markings 212 differ in their configuration, that is to say for example their form and/or their pattern, so that they are distinguishable to a detection apparatus.

For example, at least one adjustment marking 212 comprises a line pattern and/or crosses and/or circle structures. In advantageous variants, at least one adjustment marking 212 is not rotationally symmetrical, so that not only its position, but also its orientation in the geometric plane of areal extent of the marked flat component 125 can be identified and is detectable.

When a plurality of adjustment markings 212 are provided, at least some of these adjustment markings 212 are arranged distanced far from one another in relation to the geometric plane of areal extent of the marked flat component 125, as shown by way of example in FIG. 3 for the adjustment marking 212I and 212II on the one hand and, for example, the adjustment markings 212III and 212IV arranged distanced far therefrom.

For example, the function region 172 is arranged between two adjustment markings 212 situated distanced from one another, and/or adjustment markings 212 situated distanced far from one another are formed on different, for example opposite portions of the edge region 184.

For example, adjustment markings 212 situated distanced far from one another are formed in diagonally opposite corner regions of the edge region 184.

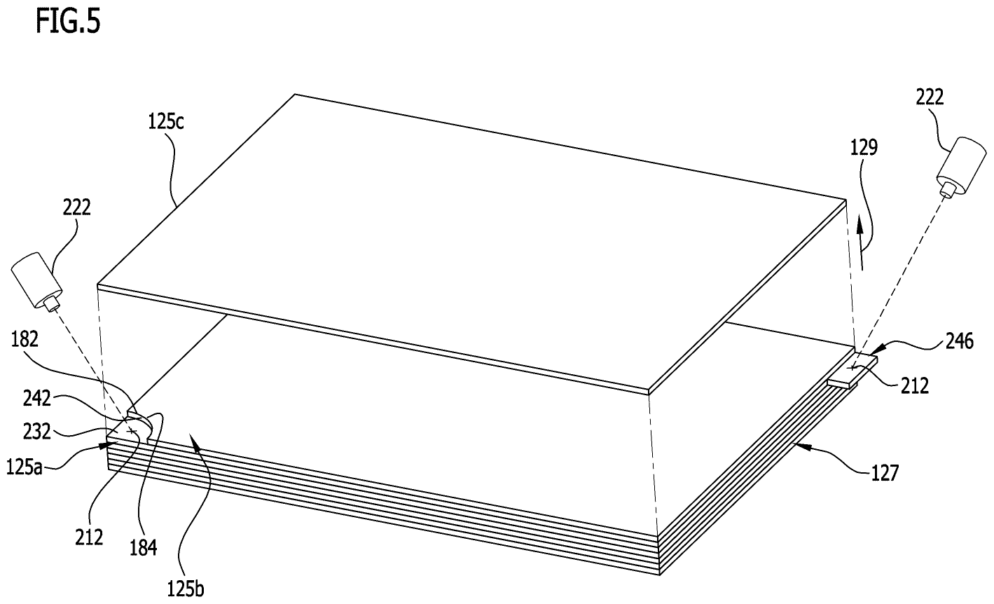

The adjustment marking 212 is preferably formed on an outer side, in particular on a surface portion 232 of the marked flat component 125, which outer side or surface portion, in the stack 127, faces the flat component 125 arranged next in the stacking direction 129, as is shown by way of example in FIG. 5 for the marked flat component 125a and the flat component 125b stacked next thereon.

In particular, the flat component which is stacked next on the marked flat component is formed as a membrane component 144, wherein the marked flat component is formed in particular as a bipolar plate 143.

The flat component which is stacked next on the marked flat component is advantageously formed material-free in the region lying above the adjustment marking 212 in the stacking direction 129.

In particular, the flat component 125 stacked next on the marked flat component 125 is formed material-free in a region of a projection of the adjustment marking 212 of the marked flat component 125 onto the geometric plane of extent of the flat component 125 stacked next.

In some expedient variants, the flat component 125 stacked directly next has a cutout 242 in the region above the adjustment marking 212, so that the adjustment marking 212 is not covered and is optically detectable.

For example, in some variants the cutout 242 is formed in the flat component 125 such that material portions surround the cutout peripherally.

In expedient variants, the cutout 242 is formed as an indentation in the edge region 184, as shown by way of example in FIG. 5. In particular, in this case the edge 182 of the flat component, in the region of the cutout 242 formed as an indentation, is set back in relation to an outer contour of the stack 127, so that the adjustment marking 212 is not hidden.

For example, the cutout 242 defines the predefined position region 216 for the adjustment marking 212, and/or at least the position region 216 is not covered on account of the cutout.

In some expedient variants, the flat component 125 marked with the adjustment marking 212 has a marking portion 246, which protrudes beyond an outer contour of the stack 127, is provided with the adjustment marking 212, and in which in particular the predefined position region 216 is situated, as is shown by way of example in FIGS. 4 and 5.

For example, the marking portion 246 protrudes some millimeters beyond the outer contour of the stack 127.

In particular, in the case of the cutout 242 formed as an indentation and/or in the case of the protruding marking portion 246, a projection of the adjustment marking 212 and for example of the associated position region 216 onto the geometric plane of extent of the flat component 125 stacked next is thus situated in this geometric plane of extent outside the extent of this next-stacked flat component 125, said extent of this next-stacked flat component extending as far as its edge 182.

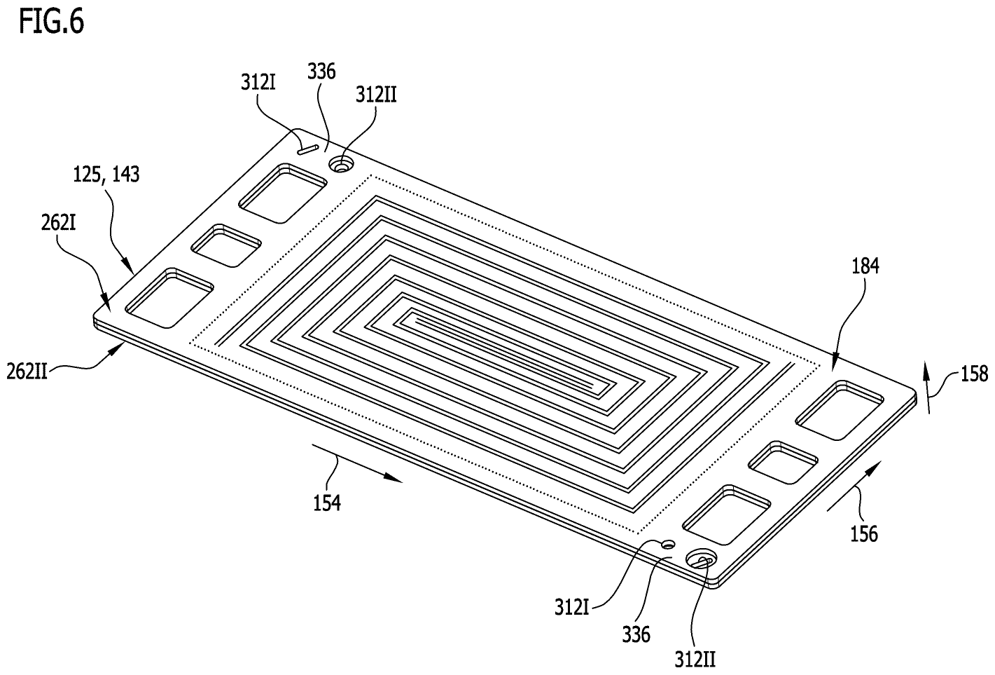

In particular, at least some flat components 125, expediently at least most flat components 125 formed as bipolar plates 143, are formed substantially from at least two in particular metal flat products 262, as shown by way of example in FIG. 6 for a variant with two flat products 262I and 262II, wherein in variants at least one further flat product also co-forms a corresponding flat component 125.

In particular, the flat products 262 of a flat component 125 form layers thereof.

Flat products 262 of a flat component 125 are arranged lying on one another in the vertical direction 158 running substantially perpendicularly to the geometric plane of areal extent of the flat component 125.

Insofar as the flat products 262 of a flat component 125 are formed at least substantially the same in respect of their basic function and/or configuration, they will be described jointly hereinafter with reference to “the flat product 262”.

For example, the flat product 262 is a metal sheet.

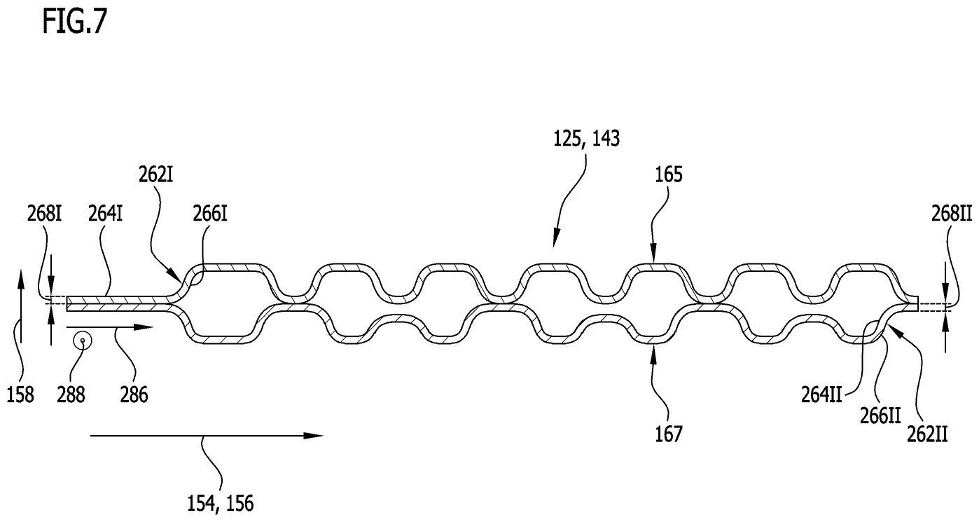

The flat product 262 has two opposite flat sides 264 and 266, which are spaced from one another by a thickness 168, as is shown by way of example in FIG. 7.

In the case of flat components 125 formed of a plurality of flat products 262, respective outer flat sides 264, 266 of two outer flat products 262 form the two-dimensional outer sides 165, 167 of the flat component 125 and inner flat sides 264, 266 are arranged facing a flat side 264, 266 of a further flat product 262, so that for example the outer flat side 264I of the flat product 262I forms the outer side 165 and the flat side 266II of the flat product 262II forms the outer side 167 and the inner flat sides 266I and 264II of the flat products 262I and 262II are arranged opposite one another, as is shown by way of example in FIG. 7.

In particular, in the case of a flat component formed as a bipolar plate 143, a respective flat product 262, which forms one of the outer sides 165, 167 of the flat component, forms an electrode or an associated cell unit 124.

In particular, the flat product 262 has a thickness 268 which is much smaller, in particular at least 10 times smaller, for example at least 100 times smaller, than extents of the flat product 262 in directions of extent 286 and 288 which run at least substantially perpendicularly to one another and which run at least locally at least substantially perpendicularly to the thickness direction in which the thickness 168 is measured.

In particular, structures which result in locally different heights of the flat component 125 are formed in the flat products 262.

In the function region 172 of flat components which are formed in particular as bipolar plates 143, at least some of the structures formed in a flat product expediently form at least some fluid-guiding structures of the flat component.

Since, preferably, structures rising from the plane of areal extent, for example the fluid-guiding structures, are formed in the flat product 262, the directions of extent 286 and 288 of the flat product 262 do not necessarily run locally at least substantially parallel to the plane of areal extent, but for example the directions of extent 286 and 288 averaged over the extent of the flat component 125 in the directions of areal extent 154 and 156, run at least approximately parallel to the plane of areal extent.

Due to the structures emerging from the plane of areal extent, such as the fluid-guiding structures, an extent of the flat component 125 in the vertical direction 158 is greater than the sum of the thicknesses 268 of the flat product 262 forming the flat component 125, as is shown by way of example in FIG. 7.

At least one flat product 262, preferably each flat product 262, of a flat component 125 formed from a plurality of flat products 262, for example a flat component formed as a bipolar plate 143, preferably has at least one alignment structure 312, which, at least in the state of the flat products arranged one above the other in order to form the flat component 125, is accessible and/or is exposed by the other one or more of the plurality of flat products 262 of the flat component 125.

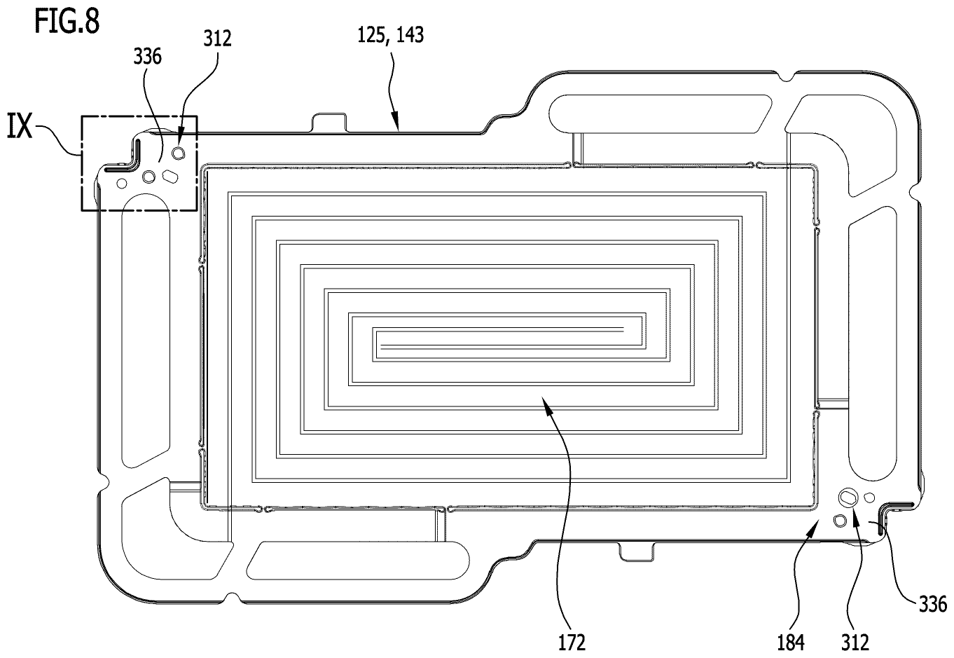

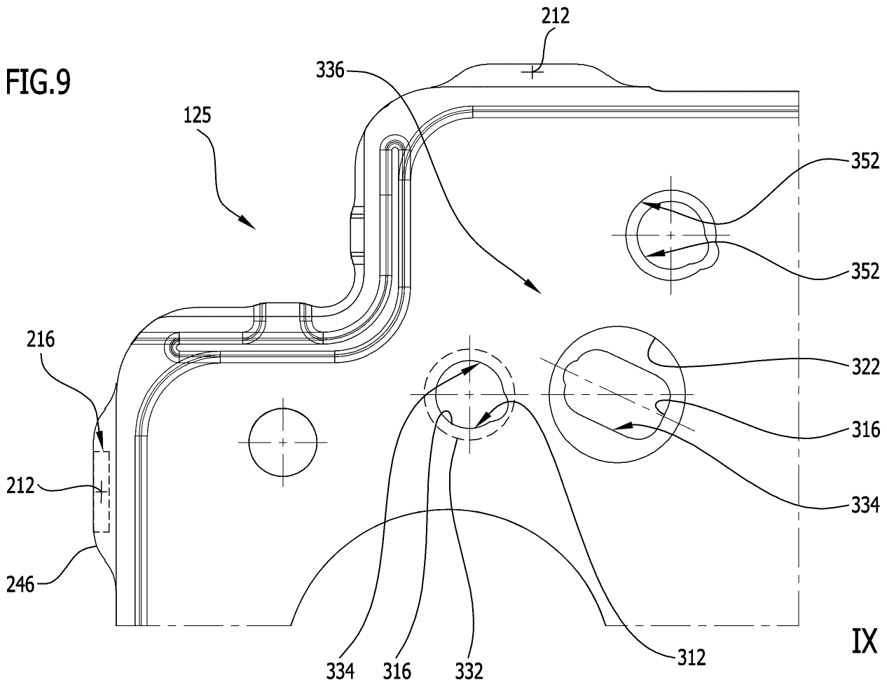

A plan view of a flat component 125 with alignment structures 312 in its flat products 262 is shown by way of example in FIGS. 6 and 8, and variants of configurations of the alignment structures 312 are explained in conjunction with the exemplary depictions in FIGS. 9 to 11.

For example, in the case of the flat components 125 formed from the flat products 262I and 262II, each of the flat products 262I, 262II has an alignment structure 312I or 312II or preferably a plurality of, for example two, alignment structures 312I or 312II, wherein the alignment structures 312I, 312II are formed the same at least in principle and/or different features are exchangeable, insofar as nothing to the contrary is explicitly explained hereinafter, and therefore the plurality of alignment structures 312I, 312II are explained jointly hereinafter and reference is made merely to the alignment structures 312.

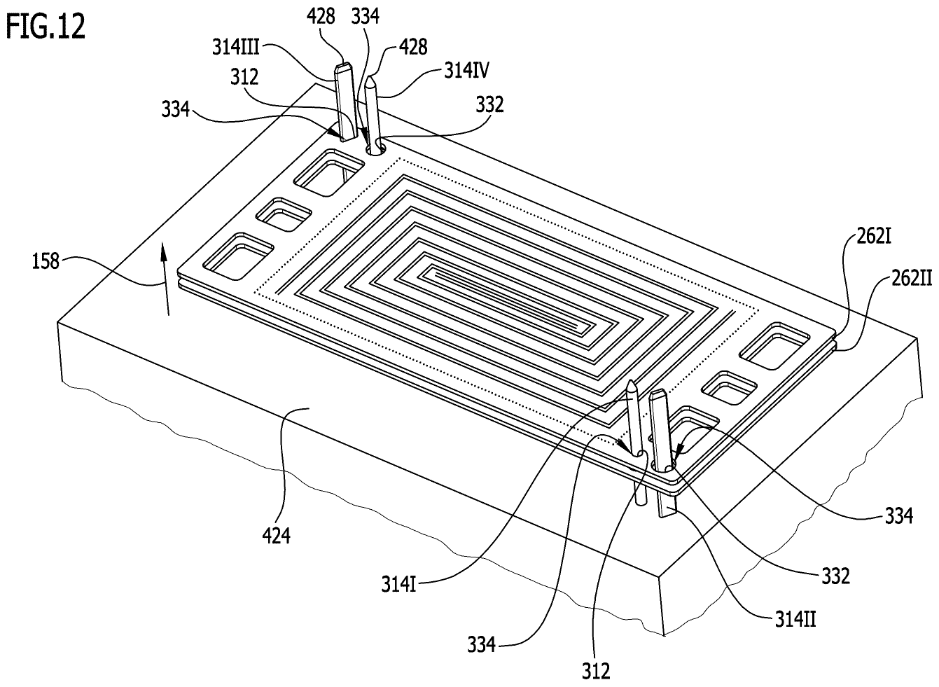

The alignment structure 312 is formed such that an alignment element 314 of a system for producing the fuel cell device, in particular for producing the flat component 125, can engage the alignment structure 312, in particular mechanically, in order to align and preferably hold the flat product 262, as shown by way of example in FIG. 12.

The alignment structure 312 is preferably formed as an aperture 316 which is continuous in the vertical direction 158 and extends between the two flat sides 264 and 266 of the flat product 262, as shown by way of example in FIGS. 9 to 11.

For example, the aperture 316 for at least one alignment structure 312 is formed at least substantially as a round hole and/or slot, wherein in this embodiment the alignment structures 312 of a flat product 262 preferably differ.

In particular, a plurality of alignment structures of a flat product 262 are embodied such that, when alignment elements 314 engage the alignment structures 312, an arrangement, in particular position and/or orientation, of the flat product 262 is not excessively over-determined.

For example, a flat product has a slot and a round hole as alignment structures.

In particular, the alignment structure 312 is formed interaction-free relative to the one other flat product 262 or relative to the other flat products 262 of the flat component 125, so that the alignment structure 312 therefore, in particular at least when aligning the flat product 262 provided with the alignment structure 312, does not interact with any further flat product 262 of the flat component 125.

In particular, the alignment structure 312 is accessible and is exposed in an exposure direction 322, which advantageously corresponds at least substantially to the vertical direction 158 of the flat component 125.

In particular, the further flat product 262 or the further flat products 262 of the flat component 125 is or are formed material-free in the projection at least of the alignment structure 312, and preferably additionally is or are also formed material-free in the projection of a tolerance region 326 surrounding the alignment structure 312.

The tolerance region 326 surrounds the alignment structure 312, preferably in a closed manner peripherally.

In particular, the tolerance region 326, in directions running at least substantially perpendicularly to the exposure direction 322, that is to say in particular running at least substantially parallel to the geometric plane of extent, starting from the alignment structure 312 and away therefrom, has an extent 328 which corresponds at least to a tolerance that is allowed when aligning the flat product 262 provided with the alignment structure 312 relative to at least one further flat product 262, in particular relative to all flat products 262 of the flat component 125.

In particular, the one other flat product 262 or the plurality of other flat products 262 of the flat component 125 have a cutout 332 above or below the alignment structure 312 in the exposure direction 322, by means of which cutout the alignment structure 312 is accessible and exposed in the exposure direction 322.

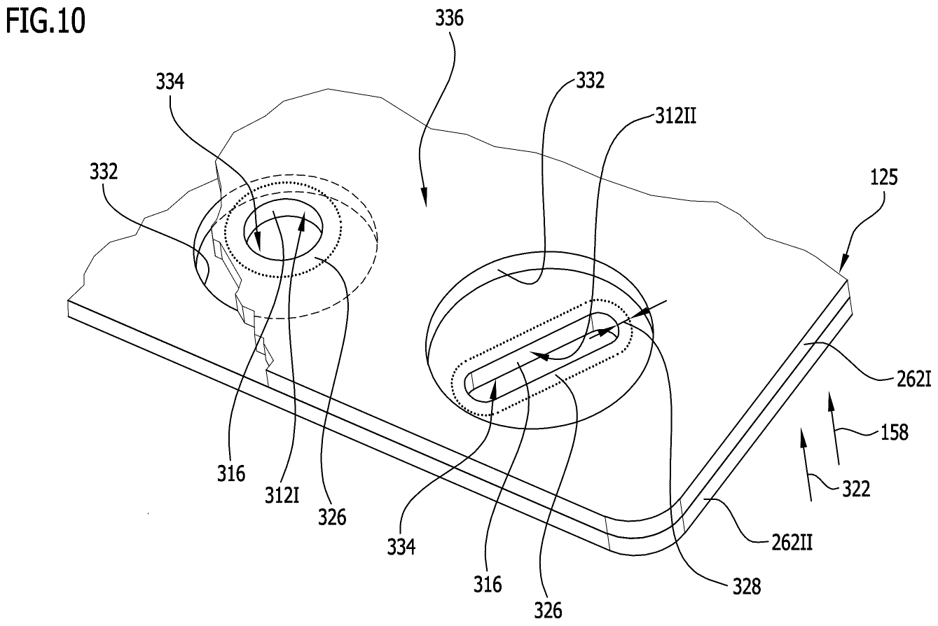

Here, in some variants, the cutout 332 is a cutout within the extent of the other flat product 262 and this cutout is surrounded peripherally by the material of the flat product 262, as is shown by way of example in FIG. 10 for two cutouts 332.

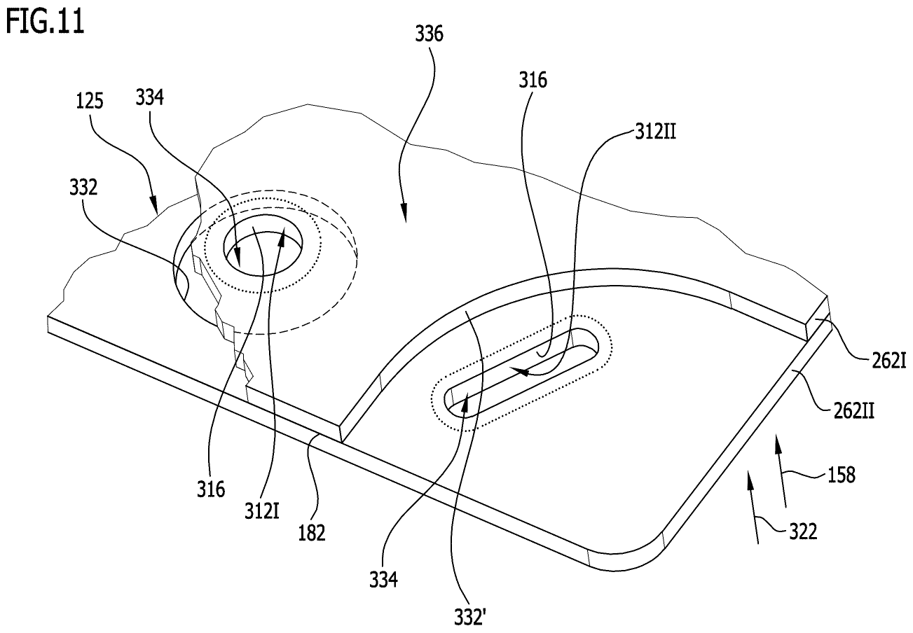

In some variants, the cutout 332 is a cutout at the edge of the flat product 262 and is formed for example as an indentation. In this case, the flat product 262 provided with this cutout 332, in the region of this cutout 332, does not extend as far as the flat product 262 having the corresponding alignment structure 312, for example it does not extend as far as the edge 182 of the flat component 125. Rather, an edge of the flat product 262 with such a cutout 332 is set back in the region of this cutout 332 behind the alignment structure 312 and preferably behind the tolerance region 326. This is shown by way of example in FIG. 11 for a cutout 332′, wherein a further depicted cutout 332 is surrounded peripherally by the material of the corresponding flat product 262.

In particular, a passage 334 through the flat component 125, said passage running continuously through the flat component 125 in the exposure direction 322 and opening out at each of the two outer sides 165, 167, is thus formed in the region of the alignment structure 312.

Here, the passage 334, in the region of the flat product 262 provided with the alignment structure 312, which is formed in particular as an aperture 316, has its minimal extent at least substantially perpendicularly to the exposure direction 322 and is wider in the region of the other flat product 262 or the other flat products 262 at least approximately perpendicularly to the exposure direction 322, and in particular is provided with an extent that is at least the same size as or greater than the extent of the alignment structure 312 plus the admissible tolerance, so that the alignment structure 312 and the tolerance region 162 surrounding it are accessible and exposed, in particular on both sides.

At least one flat product 262, for example all flat products 262, of a flat component 125 preferably has at least two alignment structures 312 arranged distanced from one another, wherein in particular the function region 172 is situated spatially between the alignment structures 312 distanced far from one another, in particular in relation to the directions of areal extent 154, 156. In particular, the at least two alignment structures 312 arranged distanced far from one another are situated distanced from one another with a spacing which corresponds at least to a minimal extent of the flat component 125 in the plane of areal extent thereof.

In each case at least one alignment structure 312 in at least two flat products 262, for example in each case one alignment structure 312 in each of the plurality of flat products 262 of the flat component 125, in relation to their distancing in a direction running substantially parallel to the geometric plane of areal extent, are preferably situated close to one another, in particular these alignment structures are situated in a locally delimited alignment portion 336 of the flat component 125.

For example, an extent of a respective alignment portion 336 in the geometric plane of areal extent is at most ten times as large, for example at most five times as large, as in extent of a respective alignment structure 312.

In particular, in a respective alignment portion 336 in at least one of the flat products 262, in particular in each of the plurality of flat products 262, there is formed in each case an alignment structure 312 and a respective cutout 332 for the alignment structure 312 in the other flat product 262 or for the alignment structures 312 in the other flat products 262.

For example, at least two alignment portions 336 are arranged situated distanced far from one another, wherein for example the function region 172 is arranged between the alignment portions 312 arranged situated distanced far away and/or the alignment portions 336 arranged situated distanced far from one another are distanced from one another by a spacing which corresponds at least to a minimal extent of the flat component 125 in the geometric plane of areal extent.

For example, at least one alignment structure 312 is, in particular at least some, in particular all, alignment structures 312 are arranged in the edge region 184 of the flat component 125.

In particular, at least one alignment portion 336 is, in particular at least some, in particular all, alignment portions 336 are, arranged in the edge region 184.

It is particularly expedient if at least the flat product 262 provided with the alignment structure 312 and at least one other flat product 262 have a respective control pattern 352, on the basis of which a correct positioning of the at least two flat products 262 relative to one another can be checked advantageously.

For example, the control patterns 352 are patterns formed in the respective flat product 262.

In particular, the control patterns 352 are apertures formed in the respective flat product 262 and are advantageously arranged one above the other, for example concentrically, in the vertical direction 158 in the aligned state.

By way of example, two control patterns 352, formed substantially as round holes, of two flat products 262 of the flat component 125 are shown by way of example in FIG. 9, wherein, in the correctly aligned state, the two round holes lie one above the other at least substantially concentrically, and therefore the correct alignment of the two flat products relative to one another is identifiable.

In particular, a method for producing a fuel cell device, in particular for producing a stack of flat components formed from flat products, comprises at least one or more of the steps explained hereinafter.

In particular, at least two flat products 262 are provided in order to produce a flat component 125 forming in particular a bipolar plate 143.

At least some of the flat products 262 are preferably provided with at least one alignment structure 312.

In particular, at least some flat products 262 are provided with at least one alignment structure 312 by at least one punching method, in particular at least in part by shearing.

The shearing is expedient because the alignment structure 312 can be formed in a precise manner as a result.

In particular, it is provided here that the alignment structure 312, in particular an aperture 316 thereof, is formed for the most part, but for example not entirely, by shearing and in a further step the material to be removed is ultimately and fully severed, whereby, in the case of the alignment structure 312, in particular the aperture 316, for example the round hole and/or slot, a projection is formed in the formed structure as a result of the ultimate severing, for example by punching.

The at least partial forming of at least some structures in the function region 172, in particular of fluid-guiding structures, in at least one flat product 262 is preferably performed in a production step with the at least partial forming of at least one alignment structure 312, preferably by the same tool. In particular, the tool is a punching tool, which impresses structures into the function regions 172 and at least partially punches out the alignment structure 312, for example forms it in part by shearing.

In the other flat product 262 or the other flat products 262, the cutout 332 for exposing the alignment structure 312 is for example formed in the at least one flat product 262 by a simple and expedient, but imprecise separation method, for example by punching, since precision is not necessary for this material-free space.

For example, control patterns 352 are formed in at least some flat products 262.

A control pattern 352 is preferably formed at least for the most part by a precise method, for example by shearing, and in particular the material is ultimately severed in a further step, for example by punching, whereby for example a projection is created in the control pattern.

The other flat product 262 is, or the other flat products 262 are, advantageously formed material-free in the region of the alignment structure 312 and preferably the tolerance region 326 surrounding this alignment structure 312, so that the one flat product 262 provided with the alignment structure 312 can be aligned independently of the other flat product 262 or the other flat products 262, since the alignment element 314, which in particular is adapted in respect of its size to the alignment structure 312, does not engage said other flat product or said other flat products.

In particular, a cutout 332, 332′ is formed in the at least one other flat product 262 correspondingly to the alignment structure 314 in the at least one flat product 262, for example by punching.

A respective alignment element 314 of a system for producing the flat component of the fuel cell device then engages the corresponding alignment structure 312 of the flat product 262 and aligns this flat product 262, and the alignment elements 314 preferably hold the flat products 262 in the aligned arrangement until the flat products 262 are joined together to form the flat component 125.

In particular, at least one alignment element 314 is provided at a machine station for assembling and producing the flat component 125, wherein advantageously at least one respective alignment element 314 is provided at this machine station for aligning and preferably for holding at least most of the flat products 262, for example all flat products 262.

By way of example, a variant is shown in FIG. 12, in which the alignment elements 314I and 314III are provided and configured for aligning and holding the flat product 262I, and the alignment elements 314II and 314IV are provided and configured for aligning and holding the flat product 262II.

Here, the at least one alignment element 314 provided and configured for aligning a corresponding flat product 262 is configured, for alignment, to interact, in particular mechanically and in particular with an accurate fit, with an alignment structure 312 of the flat product 262 to be aligned and, at the same time, at least substantially not to interact with the other flat product 262 or the other flat products 262 of the flat component 125 to be produced, at least when this flat product 262 not to be aligned or the flat products 262 not to be aligned are arranged correctly, at least roughly, in the vertical direction 158 above or below the flat product 262 to be aligned for the assembly of the flat component 125, wherein a flat product 262 is arranged correctly at least roughly when its rough alignment already corresponds to the correct alignment, however, deviations in the alignment beyond the allowed tolerance region, for example deviations beyond ten times the tolerance region, are still possible.

In particular, the alignment elements 314 are formed as rigid alignment elements 314. For example, the alignment elements 314 are pins extending in a longitudinal direction, wherein their longitudinal direction is oriented at least substantially parallel to the vertical direction 158 of the flat component 125 to be produced.

The alignment elements 314 formed for example as pins expediently extend away from a support 424 to an element end 428, wherein a respective alignment element 314 in the region of its element end 428 is preferably formed tapering to its element end 428.

The alignment elements 314, which in particular are rigid, are advantageously arranged fixedly relative to one another in an arrangement coordinated exactly with one another, so that a flat product 262, which interacts with the alignment elements 314 provided for it, is correctly aligned as a result of the interaction.

In the method, the station having the plurality of alignment elements 314 is loaded with the plurality of flat products 262, wherein at least some, in particular at least most, flat products 262 in each case come into engagement by their respective at least one alignment structure 312 with at least one alignment element 314 and are thus aligned.

In particular, a respective alignment element 314 formed in particular as a pin reaches through the corresponding alignment structure 312 formed as an aperture 316, wherein the other flat product 262 or the other flat products 262 are formed material-free at least in the region of this alignment element 314 and in particular additionally in the region of a tolerance region 326 surrounding this alignment element 314 correspondingly, so that these do not interact with this alignment element 314 and can be aligned independently thereof.

A respective alignment element 314 expediently reaches through a passage 334 formed by the plurality of flat products 262 and interacts merely with the flat product 262 to be aligned, since the passage 334 has its smallest extent transverse to the vertical direction 158 and/or its narrowest region in the region of this flat product 262 to be aligned, and the alignment element 314 has a thickness transverse to its longitudinal extent that corresponds to this extent of the passage 334 in the region of the alignment structure 312 of the flat product to be aligned, in particular with an accurate fit.

The thickness of the alignment element 312 along its longitudinal extent, where applicable apart from a region at its element end 428, is preferably at least substantially constant.

A threading-in of the flat product 262 to be aligned onto the alignment element 314 is expediently simplified by a tapering in the region of the element end 428.

The flat products 262 thus aligned correctly in relation to one another and in particular precisely are expediently joined together, in particular welded together, wherein the flat products 262 are advantageously also held in the aligned arrangement up to and during the joining together, in each case by the corresponding at least one alignment element 314.

In particular, in the method, a stack 127 of flat components 125, in particular of bipolar plates 143 and membrane components 144, is produced by providing these flat components 125 and stacking them one on top of the other and preferably joining them.

In particular, at least one flat component 125, preferably at least most bipolar plates 143, is provided here in each case with at least one adjustment marking 212, preferably in a respective predefined position region 216.

At least the flat component, which in particular is a membrane component 144, which is stacked directly next onto the flat component provided with at least one adjustment marking 212, is formed material-free in the region of the at least one adjustment marking 212, so that, at least when the two flat components 125 are aligned roughly relative to one another, the adjustment marking 212 is still detectable and/or is not covered.

For example, for this purpose, a cutout 332 is formed in the next-stacked flat component 125 or the adjustment marking 212 is formed on a protruding portion.

The flat component arranged closest, for example the flat component 125b, is placed and assembled on the flat component 125 provided with an adjustment marking 212, for example the flat component 125a, wherein the adjustment marking 212 is not covered by the forming and arrangement of the flat components 125 and is still detectable for a detection apparatus 222, in particular an optical detection apparatus, as is shown by way of example in FIG. 5.

In the case of the arrangement of yet a further flat component 125, for example the flat component 125c, the at least one adjustment marking 212 of the flat component 125 marked thereby, for example the flat component 125a, is still identifiable, although at least one further flat component 125, for example the flat component 125b, is arranged on the marked flat component 125.

The at least one detectable adjustment marking 212 is advantageously detected by a detection apparatus 222, for example an optical detection apparatus, and the actual arrangement of the flat component 125 marked by this adjustment marking 212, here for example the flat component 125a, is thus detected and the yet further flat component 125, here for example the flat component 125c, is adjusted relative to the identifiable adjustment marking 212 and thus relative to the actual arrangement of the flat component 125 marked by this adjustment marking 212, here for example the flat component 125a, and in the state thus adjusted is stacked on the flat component 125, here for example on the flat component 125b, which is already arranged on the marked flat component 125.

The marked flat component 125, for example the flat component 125a, and the yet further flat component 125, for example the flat component 125c, are thus arranged in the stack 127 preferably adjusted precisely relative to one another, although at least one further flat component 125, for example the flat component 125b is also arranged between these flat components 125.

In particular, in the case of a flat component 125 formed from a plurality of flat products 262, the plurality of flat products 262 are joined and provided with at least one adjustment marking 212 in the same machine station, for example both by welding, preferably by the same welding device.

For example, the, in particular optical, detection apparatus 222 also detects the predefined position region 216 and detects whether the adjustment marking 212 is situated within the predefined position region, so that a further control step to check for correct manufacturing of the flat component 125 is hereby performed.

For example, the, in particular optical, detection apparatus 222 identifies here the position region 216 in respect of its arrangement relative to the edge 182 and/or at contours of the edge 182.

### LIST OF REFERENCE NUMERALS

100 fuel cell device
110 fuel cell unit
112 line system
114 line device for fuel medium
116 line device for oxidation medium
124 cell units
125 flat component
127 stack
129 stacking direction
132 temperature-control device
134 line device of the temperature-control device
143 bipolar plate
144 membrane component
154 direction of areal extent
156 direction of areal extent
158 vertical direction
165 outer side
167 outer side
172 function region
182 edge
184 edge region
186 openings
198 weld seam
212 adjustment marking
216 position region
222 detection apparatus
232 surface portion
242 cutout
246 marking portion
262 flat product
264 flat side
266 flat side
268 thickness
286 direction of extent
288 direction of extent
312 alignment structure
314 alignment element
316 aperture
322 exposure direction
326 tolerance region
328 extent of the tolerance region
332 cutout
334 passage
336 alignment portion
352 control pattern
424 support
428 element end

1. A bipolar plate for a fuel cell device, wherein the bipolar plate is formed from a plurality of flat products, arranged one above the other in a vertical direction, wherein exactly one or each of at least some of the plurality of flat products has exactly one alignment structure or a plurality of alignment structures and at least one alignment structure of at least one flat product, at least in the state in which the plurality of flat products are arranged one above the other, is exposed by the other one or more of the plurality of flat products.

2. A fuel cell device comprising at least one fuel cell unit having at least one flat component, wherein the at least one flat component is formed from a plurality of flat products, arranged one above the other in a vertical direction, wherein exactly one or each of at least some of the plurality of flat products has exactly one alignment structure or a plurality of alignment structures, and at least one alignment structure of at least one flat product, at least in the state in which the flat products are arranged one above the other, is exposed by the other one or more of the plurality of flat products.

3. The bipolar plate in accordance with claim 1, wherein at least one of the following:
at least one alignment structure of at least one flat product is formed so as to be free of interaction with the at least one other flat product;
at least one alignment structure of at least one flat product is formed as an aperture in the flat product, said aperture being formed in particular continuously in the vertical direction;
at least one alignment structure in at least one flat product is formed in a locally delimited manner.

4. The fuel cell device in accordance with claim 2, wherein at least on of the following:
at least one alignment structure of at least one flat product is formed so as to be free of interaction with the at least one other flat product;
at least one alignment structure of at least one flat product is formed as an aperture in the flat product, said aperture being formed in particular continuously in the vertical direction;
at least one alignment structure in at least one flat product is formed in a locally delimited manner.

5. The bipolar plate in accordance with claim 1, wherein at least one of the following:
at least one alignment structure in at least one flat product is exposed at least in an exposure direction;
at least one alignment structure in at least one flat product together with a tolerance region surrounding this alignment structure is exposed, wherein the tolerance region, in a direction which runs away from the alignment structure which is surrounded by this tolerance region, has at least an extent which is greater than or the same as a tolerance for the alignment of this flat product.

6. The fuel cell device in accordance with claim 1, wherein at least one of the following:
at least one alignment structure in at least one flat product is exposed at least in an exposure direction;
at least one alignment structure in at least one flat product together with a tolerance region surrounding this alignment structure is exposed, wherein the tolerance region, in a direction which runs away from the alignment structure which is surrounded by this tolerance region, has at least an extent which is greater than or the same as a tolerance for the alignment of this flat product.

7. The bipolar plate in accordance with claim 1, wherein in a projection of at least one alignment structure of at least one flat product in an exposure direction thereof, the other one or more of the plurality of flat products are material-free.

8. The bipolar plate in accordance with claim 1, wherein, relative to at least one alignment structure of at least one flat product, at least one other flat product has a cutout, wherein the cutout is arranged congruently with the at least one alignment structure.

9. A bipolar plate in accordance with claim 1, wherein the bipolar plate, at least in the region of at least one alignment structure has a passage in an exposure direction from at least one outer side of the flat component to at least this at least one alignment structure, and the passage from the at least one outer side to an outer side opposite this outer side in the exposure direction is formed continuously through the bipolar plate.

10. The fuel cell device in accordance with claim 2, wherein at least one flat component at least in the region of at least one alignment structure has a passage in an exposure direction from at least one outer side of said at least one flat component to at least this at least one alignment structure, and the passage from the at least one outer side to an outer side opposite this outer side in the exposure direction is formed continuously through said at least one flat component.

11. The bipolar plate in accordance with claim 9, wherein an extent, which is measured in a direction of extent running perpendicularly to the exposure direction, of at least one passage is minimal at the alignment structure co-forming this passage.

12. The fuel cell device in accordance with claim 10, wherein an extent, which is measured in a direction of extent running perpendicularly to the exposure direction, of at least one passage is minimal at the alignment structure co-forming this passage.

13. The bipolar plate in accordance with claim 1, wherein at least one flat product has at least two alignment structures.

14. The bipolar plate in accordance with claim 1, wherein respective alignment structures in different flat products are arranged relative to one another offset from one another.

15. The bipolar plate in accordance with claim 1, wherein in each case at least one alignment structure is formed in at least some of the plurality of flat products, and these alignment structures are arranged close to one another.

16. The fuel cell device in accordance with claim 2, wherein at least one of the following:
at least one flat component of the at least one fuel cell unit is at least part of at least one line device for a fluid medium;
at least one flat component of the at least one fuel cell unit is at least part of an electrical device.

17. The fuel cell device in accordance with claim 2, wherein at least one flat component of the at least one fuel cell unit is a bipolar plate.

18. A method for producing a bipolar plate wherein the bipolar plate is formed from a plurality of flat products, wherein the method comprises at least the steps of providing the plurality of flat products and of forming at least one alignment structure at least in one flat product such that at least in a state in which the plurality of flat products are arranged one above the other, said formed at least one alignment structure is exposed by the other one or more of the plurality of flat products.

19. A method for producing a fuel cell device which comprises at least one fuel cell unit having at least one flat component, wherein the at least one flat component is formed from a plurality of flat products, wherein the method comprises at least the steps of providing the plurality of flat products and of forming at least one alignment structure at least in one flat product such that at least in a state in which the flat products are arranged one above the other, such formed at least one alignment structure is exposed by the other one or more of the plurality of flat products.

20. The method in accordance with claim 18, wherein in at least one flat product at least one alignment structure is formed at least in part by at least one separation method.

21. The method in accordance with claim 18, wherein in at least one flat product a function region and at least one alignment structure are formed at least in part using the same tool.

22. The method in accordance with claim 18, wherein the method further comprises at least the steps of aligning at least one flat product of the plurality of flat products independently of the other one or more of the plurality of flat products with the aid of at least one alignment structure in this at least one flat product, and joining together the aligned flat products.

23. The method in accordance with claim 18, wherein the at least one flat product with at least one alignment structure is aligned by at least one rigid alignment element engaging the at least one alignment structure.

24. The method in accordance with claim 18, wherein at least one alignment element for aligning exactly one or more flat products does not interact with the other one or more of the plurality of flat products.

25. The method in accordance with claim 18, wherein at least one alignment element and at least one alignment structure of at least one flat product to be aligned by this alignment element cooperate following the alignment of this flat product at least during a further production step.

26. A system for producing a flat component, wherein the flat component is formed from a plurality of flat products, wherein the system has at least one alignment element for aligning at least one flat product independently of the other one or more of the plurality of flat products.

27. The system in accordance with claim 26, wherein the system has, in each case, at least one alignment element for each of the plurality of flat products.

28. The system in accordance with claim 26, wherein at least one alignment element is a rigid alignment element.

29. The system in accordance with claim 26, wherein at least one alignment element is formed tapering towards an element end.

30. The system in accordance with claim 26 wherein the system has at least one tool for simultaneously at least partially forming a function region and partially forming at least one alignment structure in at least one flat product.
